(19) United States
(12) Patent Application Publication
(10) Pub. No.: US 2007/0299889 A1
(43) Pub. Date: Dec. 27, 2007

(54) Information processing apparatus performing plurality of series of predetermined processes and control program embodied in computer readable medium to be executed in information processing apparatus

(75) Inventors: Toshiya Shozaki, Osaka-shi (JP); Kaitaku Ozawa, Itami-shi (JP); Kimie Ando, Kawasaki-shi (JP); Junichi Hase, Osaka-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 11/642,865

(22) Filed: Dec. 21, 2006

(30) Foreign Application Priority Data
May 17, 2006 (JP) 2006-138357

(51) Int. Cl. G06F 17/30

(52) U.S. Cl. 707/203

(57) ABSTRACT

In order to easily change the settings for executing a plurality of series of processes, MFP includes a storage portion to store program key definition data defining a plurality of series of processes, a process execution portion to read the program key definition data from the storage portion to execute a plurality of series of processes defined by the program key definition data, a program key change detection portion to detect that a part of a plurality of series of processes defined by the stored program key definition data is changed, and a program key change portion to change a process other than the changed process of a plurality of series of processes defined by the program key definition data detected as being changed.

This application is based on Japanese Patent Application No. 2006-138357 filed with Japan Patent Office on May 17, 2006, the entire content of which is hereby incorporated by reference.

### BACKGROUND OF THE INVENTION

1. Field of the Invention

The present invention relates to an information processing apparatus and a control program embodied in computer readable medium, and more particularly to an information processing apparatus performing a plurality of series of predetermined processes and a control program embodied in computer readable medium to be executed in the information processing apparatus.

2. Description of the Related Art

In recent years, with increased variety of functions of Multi Function Peripheral (referred to “MFP” hereinafter), definition data that defines a process performed by MFP and a setting value for executing the process are related with a program key or BOX (a region in which a document is stored) in order to facilitate the operation of MFP. For example, a user selects a program key to give an instruction for execution, so that a predetermined process is performed in MFP according to a setting value defined by definition data. On the other hand, in some MFPs, recipient information is registered beforehand in an address book, so that information of recipient is set by a user specifying one recipient registered in the address book. In MFP that stores an address book, definition data related with a program key allows reference to recipient information registered in the address book. Japanese Laid-Open Patent Publication Nos. 2003-298823 and 2001-160895 disclose a technique to prevent wrong transmission when an address book is changed.

However, when recipient information of an address book that is referred to by definition data related with a program key or BOX is changed to another receiver information, a process according to the changed definition data is not performed properly. For example, when receiver information for facsimile transmission which is registered in an address book is referred to by definition data, the receiver information referred to by the definition data may be changed to receiver information for email transmission. When a process is performed according to the changed definition data, data for facsimile transmission will be transmitted via email. In this case, such inconsistency may be caused in that the setting value set for facsimile transmission cannot be used for emails as it is, and thus a job may not be executed. Moreover, when the setting of definition data related with BOX is changed, the content of a process executed according to definition data which defines the BOX as a destination and is related with the program key becomes inconsistent.

On the other hand, it is an extremely cumbersome operation for the user to pay attention to any change in destination data or definition data, pick up other definition data including the settings related with the changed part one by one, and make corrections individually.

### SUMMARY OF THE INVENTION

The present invention is made to solve the aforementioned problems. An object of the present invention is to provide an information processing apparatus capable of easily changing a part of the settings for executing a plurality of series of processes and a control program embodied in a computer readable medium to be executed in the information processing apparatus.

Another object of the present invention is to provide an information processing apparatus capable of easily changing processes common among a plurality of settings for executing a plurality of series of processes and a control program embodied in a computer readable medium to be executed in the information processing apparatus.

In order to achieve the aforementioned object, in accordance with an aspect of the present invention, an information processing apparatus includes: a storage portion to store definition data defining a plurality of series of processes; a process execution portion to read the definition data from the storage portion to execute the plurality of series of processes defined by the definition data; a change detection portion to detect that a part of the plurality of series of processes defined by the stored definition data is changed; and a definition data change portion to change a process other than the changed process of the plurality of series of processes defined by the definition data detected by the change detection portion.

In accordance with the present invention, a plurality of series of processes defined by definition data are executed. When a part of a plurality of series of processes defined by the definition data is changed, of a plurality of series of processes defined by the changed definition data, a process other than the changed process is changed. Therefore, even after a part of the processes is changed, a plurality of series of processes are executed properly, so that a part of the processes can be changed easily. As a result, it is possible to provide an information processing apparatus capable of easily changing a part of the settings for executing a plurality of series of processes.

In accordance with another aspect of the present invention, an information processing apparatus includes: a first definition data storing portion to store first definition data defining a plurality of series of processes; a process execution portion to read the first definition data from the first definition data storing portion to execute the plurality of series of processes defined by the first definition data; a second definition data storing portion to store second definition data related with the first definition data to define a partial process that is a part of the plurality of series of processes; a change detection portion to detect a change of the second definition data stored in the second definition data storing portion; and a change portion to change the first definition data related with the second definition data, in response to a change of the second definition data.

In accordance with the present invention, when the second definition data is changed, the first definition data related with the second definition data is changed. As a result, it is possible to provide an information processing apparatus capable of easily changing a part of the settings for executing a plurality of series of processes.

Preferably, the first definition data storing portion stores a plurality of the first definition data, and the information processing apparatus further includes an extraction portion, in response to detection of a change of the second definition data by the change detection portion, to extract related first definition data that is related with said changed second definition data from a plurality of first definition data stored in the first definition data storing portion.

In accordance with the present invention, of a plurality of first definition data, related first definition data that is related with the changed second definition data is extracted and changed. Therefore, when the second definition data that is referred to in common by a plurality of first definition data is changed, a plurality of series of processes defined by all the first definition data related with the changed second definition data can be executed properly. As a result, it is possible to provide an information processing apparatus capable of easily changing processes common among a plurality of settings for executing a plurality of series of processes.

In accordance with a further aspect of the present invention, a control program embodied in a computer readable medium includes the steps of: storing definition data defining a plurality of series of processes; reading the stored definition data to execute the plurality of series of processes defined by the definition data; detecting that a part of the plurality of series of processes defined by the stored definition data is changed; and changing a process other than the changed process of the plurality of series of processes defined by the changed definition data.

In accordance with the present invention, it is possible to provide a control program embodied in a computer readable medium in which a part of the settings for executing a plurality of series of processes can easily be changed.

In accordance with yet another aspect of the present invention, a control program embodied in a computer readable medium includes the steps of: storing first definition data defining a plurality of series of processes; reading the stored first definition data to execute the plurality of series of processes defined by the first definition data; storing second definition data related with the first definition data to define a partial process that is a part of the plurality of series of processes; detecting a change of the stored second definition data; and changing the first definition data related with the second definition data, in response to a change of the second definition data.

In accordance with the present invention, it is possible to provide a control program embodied in a computer readable medium in which a part of the settings for executing a plurality of series of processes can easily be changed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an overall configuration of a network system in accordance with an embodiment of the present invention.

FIG. 2 is a block diagram showing an exemplary hardware configuration of MFP in accordance with the embodiment.

FIG. 3A is a diagram showing an exemplary format of program key definition data.

FIG. 3B is a diagram showing exemplary first process definition data.

FIG. 3C is a diagram showing exemplary second process definition data.

FIGS. 4A and 4B are diagrams showing exemplary parameters corresponding to the image reading process.

FIG. 5A is a diagram showing an exemplary format of destination data.

FIG. 5B is a diagram showing an output method and output destination information by way of example.

FIG. 6 is a diagram showing exemplary user information.

FIG. 7 is a diagram showing an exemplary format of user data.

FIG. 8 is a functional block diagram schematically showing a function of CPU included in MFP.

FIG. 9 is a diagram showing an exemplary change instruction window.

FIG. 10 is a first flowchart illustrating an exemplary flow of a control process executed in MFP in accordance with the embodiment.

FIG. 11 is a flowchart illustrating an exemplary flow of an automatic correction process.

FIG. 12 is a flowchart illustrating an exemplary flow of Fax→Scan conversion process.

FIG. 13 is a diagram illustrating an exemplary flow of a file format conversion process performed at step S31 in FIG. 12.

FIG. 14 is a diagram showing an exemplary flow of a resolution conversion process performed at step S32 in FIG. 12.

FIG. 15 is a diagram showing an exemplary flow of a color type conversion process performed at step S33 in FIG. 12.

FIG. 16 is a flowchart illustrating an exemplary flow of Scan→Fax conversion process.

FIG. 17 is a diagram illustrating an exemplary flow of a file format conversion process performed at step S61 in FIG. 16.

FIG. 18 is a diagram illustrating an exemplary flow of a resolution conversion process performed at step S62 in FIG. 16.

FIG. 19 is a diagram illustrating an exemplary flow of a document image quality conversion process performed at step 63 in FIG. 16.

FIG. 20 is a diagram illustrating an exemplary flow of a document designation conversion process performed at step S64 in FIG. 16.

FIG. 21 is a diagram illustrating an exemplary flow of a color type conversion process performed at step S65 in FIG. 16.

FIG. 22 is a flowchart illustrating an exemplary flow of a manual correction process.

FIG. 23 is a flowchart illustrating an exemplary flow of a simple correction process.

FIG. 24 is a flowchart illustrating an exemplary flow of a detailed correction process.

FIG. 25 is a functional block diagram schematically showing a function of CPU included in MFP in accordance with a modification.

FIG. 26 is a second flowchart illustrating an exemplary flow of a control process executed in MFP in accordance with the modification.

FIG. 27 is a functional block diagram schematically showing a function of CPU included in MFP in accordance with a second embodiment.

FIGS. 28A-28D are diagrams showing exemplary formats of function BOX process definition data.

FIGS. 29A and 29B are diagrams showing exemplary function BOX process definition data after change.

FIG. 30A is a diagram showing an exemplary format of program key definition data.

FIG. 30B is a diagram showing exemplary first process definition data.

FIG. 30C is another diagram showing exemplary second process definition data.

FIG. 31 shows exemplary first process definition data of program key definition data after change.

FIG. 32 is a third flowchart illustrating an exemplary flow of a control process executed in MFP in accordance with the second embodiment.

FIG. 33 is a diagram showing an exemplary flow of a parameter inconsistency check process.

FIG. 34 is another flowchart illustrating a flow of an automatic correction process.

FIG. 35 is a fourth flowchart showing an exemplary flow of a control process executed in MFP in accordance with the second embodiment.

### DESCRIPTION OF THE PREFERRED EMBODIMENTS

The embodiment of the present invention will be described below with reference to the drawings. In the following description, the same parts are denoted by the same reference characters. Their names and function are also the same. Thus, a detailed description thereof will not be repeated.

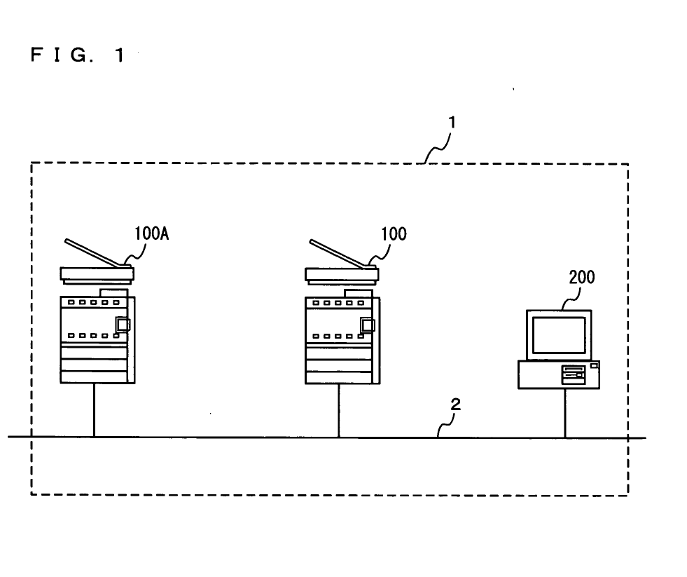

In the present embodiment, MFP (Multi Function Peripheral) will be described as an example of an information processing apparatus. FIG. 1 is a diagram showing an overall configuration of a network system according to an embodiment of the present invention. With reference to FIG. 1, a network system 1 includes two MFPs 100, 100A and a computer 200 connected to a network 2. Each of MFPs 100, 100A includes a scanner portion for reading a sheet of original manuscript to obtain image data, an image formation portion for forming an image on recording media such as a sheet of paper based on image data, and a facsimile, and has an image reading function, a copying function, and a facsimile transmission and reception function. Computer 200 is a general personal computer and its hardware configuration is well known. Therefore, description thereof will not be repeated here.

Network 2 is a local area network (LAN) and the form of connection can be wired or wireless. In addition, network 2 is not limited to a LAN and can be a wide area network (WAN) such as the Internet, a network using Public Switched Telephone Network (PSTN), and so on.

It is noted that although FIG. 1 shows that network system 1 is configured such that two MFPs 100, 100A and one computer 200 are connected to network 2 by way of example, the equipment included in network system 1 may be a facsimile, a scanner, a printer, or a computer as long as it can be connected to network 2. Furthermore, the number of equipment included in network system 1 may be more than one.

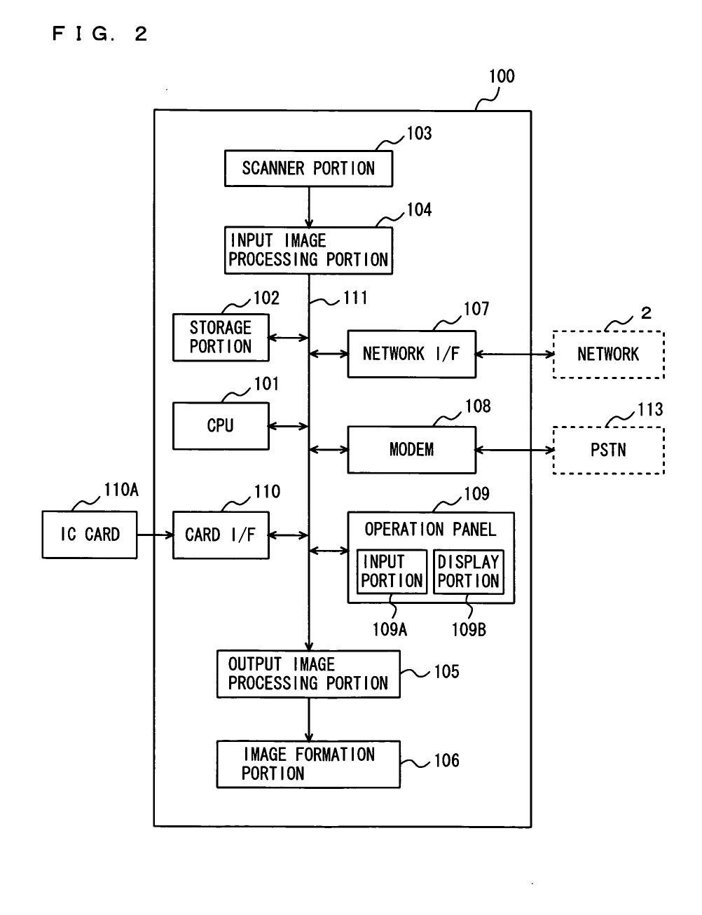

FIG. 2 is a block diagram showing an exemplary hardware configuration of MFP according to this embodiment. MFP 100 and MFP 100A have the same hardware configuration and function, and thus, here MFP 100 will be taken as an example. With reference to FIG. 2, MFP 100 includes a scanner portion 103 optically reading a document to obtain image data and an image formation portion 106 forming an image on a recording medium such as paper, and a CPU (Central Processing Unit) 101, a storage portion 102, an input image processing portion 104 processing image data output by scanner portion 103, an output image processing portion 105 performing processing suitable to output image data, a network interface (I/F) 107, a modem 108, an operation panel 109, and a card I/F 110, each connected to a bus 111.

CPU 101 controls the entire MFP 100. Storage portion 102 includes a semiconductor memory such as a ROM (Read Only Memory), a RAM (Random Access Memory) and an EEPROM (Electrically Erasable Programmable ROM) and a magnetic storage device such as a hard disk drive (HDD). CPU 101 loads a control program recorded in ROM into RAM for execution.

Scanner portion 103 includes a photoelectric transducer such as a CCD (Charge Coupled Device) and the like, and optically reads a document and outputs image data as electronic data to input image processing portion 104. Input image processing portion 104 performs a color conversion process, a color correction process, a resolution conversion process, a region determination process, and the like for the input image data, and stores the processed image data into storage portion 102.

Output image processing portion 105 reads image data from storage portion 102, performs a screen control process, a smoothing process, a pulse width modulation (PWM), and outputs the processed image data to image formation portion 106. Image formation portion 106 is a laser printer and visualizes image data input from output image processing portion 105 on a recording medium such as paper. Image formation portion 106 forms an image using toner of four colors including yellow, magenta, cyan, and black, in the case of color printing. Image formation portion 106 may be an inkjet printer.

An IC card 110A is inserted into card I/F 110. CPU 101 can access IC card 110A through card I/F 110. Network I/F 107 allows MFP 100 to connect to network 2. Network I/F 107 outputs data to network 2 according to a prescribed communication protocol and receives data from network 2 according to a prescribed communication protocol. CPU 101 can communicate with another MFP 100 or computer 200 connected to network 2 through network I/F 107. Therefore, data can be received/transmitted using, for example, SMB (Server Message Block), FTP (File Transfer Protocol), or the like.

Modem 108 allows MFP 100 to connect to PSTN 113. Modem 108 allows facsimile communications of data according to a facsimile communication protocol. Modem 108 stores the faxed data into HDD of storage portion 102. Furthermore, modem 108 includes an NCU (Network Control Unit) to allow communications with a computer connected to PSTN 113. Data received from anther computer through modem 108 is stored in HDD of storage portion 102.

Operation panel 109 includes an input portion 109A and a display portion 109B. Input portion 109A is an input device such as a touch panel, a keyboard, or a mouse for accepting an input of operation by a user of MFP 100. Display portion 109B is a liquid crystal display or an organic EL (Electro-Luminescence) display panel. When using a touch panel formed of a transparent member for input portion 109A, the touch panel is provided to overlap display portion 109B so that an instruction on a button displayed on display portion 109B can be detected. Thus, a variety of operations can be input.

It is noted that the control program executed in CPU 101 is not limited to the one stored in ROM and may be stored in EEPROM. If stored in EEPROM, the control program can be overwritten or additionally written. Therefore, computer 200 connected to network 2 can overwrite the control program stored in EEPROM of MFP 100 or additionally write a new control program. Furthermore, MFP 100 can download a control program from computer 200 connected to network 2 and store that control program in EEPROM.

Furthermore, the control program may be stored in IC card 110A so that the control program recorded in IC card 110A inserted into card I/F 110 is loaded into RAM for execution. It is noted that the control program may be recorded not only in IC card 110A but also in a medium including a magnetic tape, a cassette tape, a magnetic disk (flexible disk, hard disk, or the like), an optical disk (CD-ROM (Compact Disc-ROM)/MO (Magneto-Optical Disc)/MD (Mini Disc)/DVD (Digital Versatile Disc) or the like), an optical card, or a semiconductor memory such as a mask ROM or a flash memory. The program referred to herein includes not only a program directly executable by CPU 101 but also a program in a source program format, a compressed program, an encrypted program, or the like.

MFP 100 in accordance with the present embodiment stores program key definition data and destination data in storage portion 102. The program key definition data is related with a program key and defines a plurality of processes performed by MFP 100 and a parameter for performing each of the plurality of processes. The user specifies a program key to cause execution, so that MFP 100 reads the program key definition data related with the program key and executes a plurality of processes defined by the program key definition data according to corresponding parameters. The destination data is data that defines an output method and output destination information for specifying an output destination, that is a so-called address book. A user specifies one of the destination data, so that MFP 100 outputs data to an output destination specified by the output information defined by the destination data in an output method defined by the destination data.

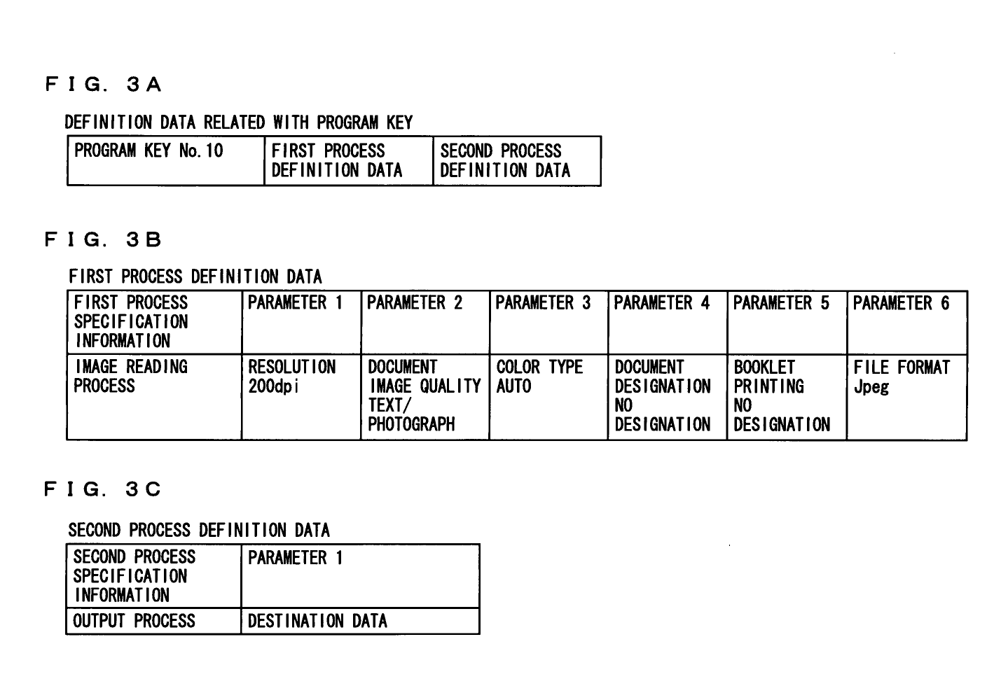

First, program key definition data will be described. FIG. 3A is a diagram showing an exemplary format of program key definition data. Referring to FIG. 3A, the program key definition data relates a key No. for identifying definition data related with a program key with a plurality of process definition data that respectively define a plurality of processes. Key No. is associated with a program key included in operation portion 109A of MFP 100. Therefore, the user specifies a program key for execution on operation portion 109A, so that operation portion 109A accepts and obtains the key No. associated with the program key. MFP 100 reads program key definition data related with the obtained key No. In the figure, a plurality of process definition data are first process definition data and second process definition data. The process definition data includes process specification information for specifying a process and a parameter required to execute a process specified by the process specification information. FIG. 3B is a diagram showing exemplary first process definition data. The first process definition data defines process specification information for specifying a first process and first to sixth parameters required to execute the first process. The process specification information defines “image reading process.” The first parameter defines “resolution.” The second parameter defines “document image quality.” The third parameter defines “color type.” The fourth parameter defines “document type.” The fifth parameter defines “booklet printing.” The sixth parameter defines “file format.” FIG. 3C is a diagram showing exemplary second process definition data. The second process definition data defines process specification information for specifying a second process and a parameter required to execute the second process. The process specification information defines “output process.” The parameter defines “destination data.” The parameter corresponding to the output process specifies destination data 125 which will be described later. Here, the parameter is a pointer that points to an address of destination data 125 stored in storage portion 102. Therefore, the parameter corresponding to the output process is a parameter that refers to destination data 125. It is noted that although here the parameter of the second process definition data is a parameter that refers to destination data, it may be destination data itself.

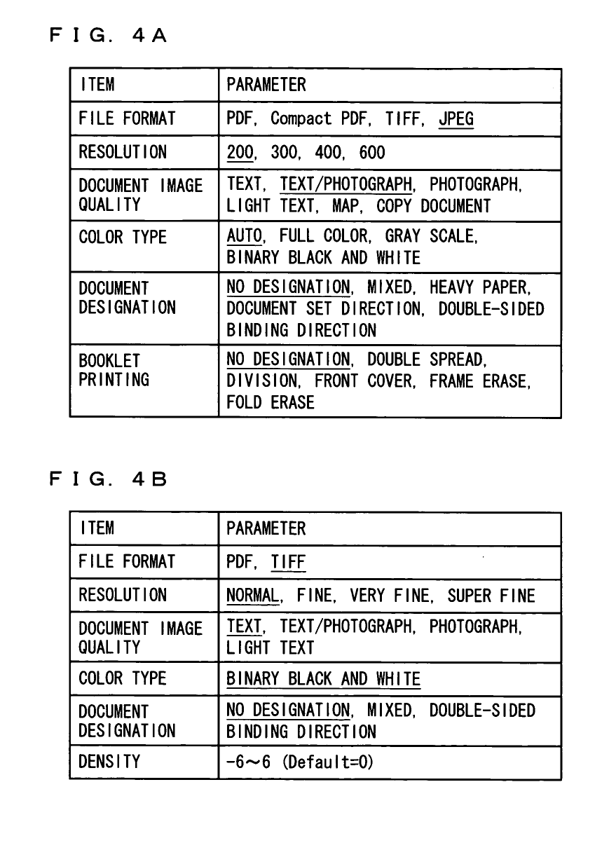

FIG. 4A and FIG. 4B are diagrams showing exemplary parameters corresponding to the image reading process. FIG. 4A shows a parameter that can be set when the output process is other than facsimile transmission and FIG. 4B shows a parameter that can be set when the output process is facsimile transmission. Referring to FIG. 4A and FIG. 4B, a parameter selected from a plurality of parameters is set in each setting item. Of a plurality of parameters, a parameter that is set by default is underlined. A parameter corresponding to the image reading process differs between when the output process is facsimile transmission and when the output process is other than facsimile transmission. When the output process is facsimile transmission, data which is output upon execution of the image reading process may not be faxed with the parameters of the image reading process corresponding to the output process other than facsimile transmission. For example, if the file format is set at JPEG (Joint Photographic Experts Group) by the parameter of the image reading process, facsimile transmission is disabled. On the contrary, when the output process is other than facsimile transmission, data which is output upon execution of the image reading process with the parameter of the image reading process corresponding to facsimile transmission is sometimes not suitable for the process other than facsimile transmission. For example, only binary black and white can be selected as the color type in the parameter of the image reading process corresponding to facsimile transmission. However, in the process other than facsimile transmission, for example, email transmission, image data having a color type of color or grayscale is preferably transmitted.

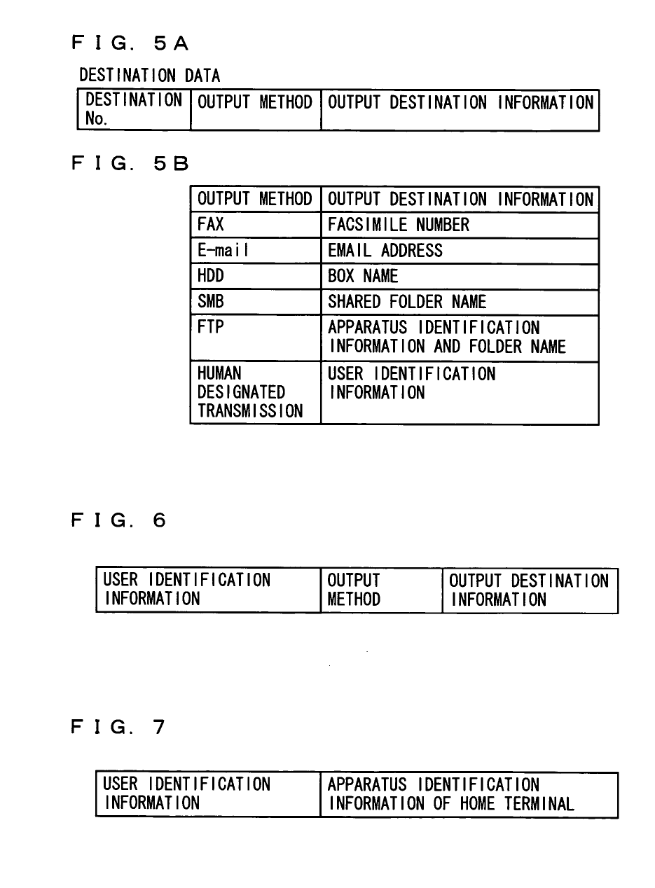

The destination data will now be described. FIG. 5A is a diagram showing an exemplary format of destination data. Referring to FIG. 5A, the destination data relates a destination No. for identifying destination data, an output method, and output destination information for specifying an output destination with each other. FIG. 5B is a diagram showing exemplary output methods and output destination information. The output methods include facsimile transmission (FAX), email transmission (E-mail), storage into HDD of storage portion 102 (HDD), SMB, FTP, and human designated transmission. The output destination information corresponding to the output method of facsimile transmission (FAX) is a facsimile number. The output destination information corresponding to the output method of email transmission (E-mail) is an email address. The output destination information corresponding to the output method of storage into HDD of storage portion 102 (HDD) is a BOX name indicating a storage area of HDD. The output destination information corresponding to the output method of SMB is a shared folder name. The output destination information corresponding to the output method of FTP is apparatus identification information and a folder name. The output destination information corresponding to the output method of human designated transmission is user identification information for identifying a user.

Here, the human designated transmission will be described. The human designated transmission is a transmission method where MFP that is mainly used among a plurality of MFPs is determined as a home terminal for each of a plurality of users. Here, MFP mainly used by each user is referred to a home terminal for the user. Upon execution of a user registration process, a home terminal displays a user registration window to accept an input of user information. Upon acceptance of user information, the home terminal stores that user information in the storage portion 102.

FIG. 6 shows a diagram showing exemplary user information. The user information includes user identification information for identifying a user, an output method, and output destination information for specifying an output destination. The output method includes facsimile transmission (FAX), email transmission (E-mail), storage into HDD of storage portion 102 (HDD), SMB, and FTP. When user information is stored, a home terminal transmits apparatus identification information for identifying the home terminal and user identification information in relation with each other to another MFP. Accordingly, another MFP receives the user identification information and the apparatus identification information from the home terminal to generate and store user data indicating the relation between the user and the home terminal. FIG. 7 is a diagram showing an exemplary format of user data. The user data is data in which user identification information and apparatus identification information of the home terminal storing that user identification information are related with each other.

Now, referring to FIG. 5B, if human designated transmission is defined in the output method in the destination data, user identification information is defined by a parameter. Therefore, MFP 100 searches user data to specify a home terminal corresponding to the user identification information and then transmits the user identification information to the home terminal. Upon reception of the user identification information, the home terminal reads and sends back user information including the received user identification information. MFP 100 thus receives user information including user identification information from the home terminal. MFP 100 outputs data to an output destination specified by the output destination information defined by the user information in an output method defined by the received user information. Alternatively, MFP 100 may transmit user identification information and data to the home terminal corresponding to the user identification information to allow the home terminal to execute the output process. The home terminal reads user information including the received user identification information and outputs the received data to an output destination specified by the output destination information defined by the user information in an output method defined by the read user information. In this human designated transmission, the user who sends data can deliver the data to a user as a destination only by designating a person (user identification information), so that the user as a destination can receive data output by the desired output method.

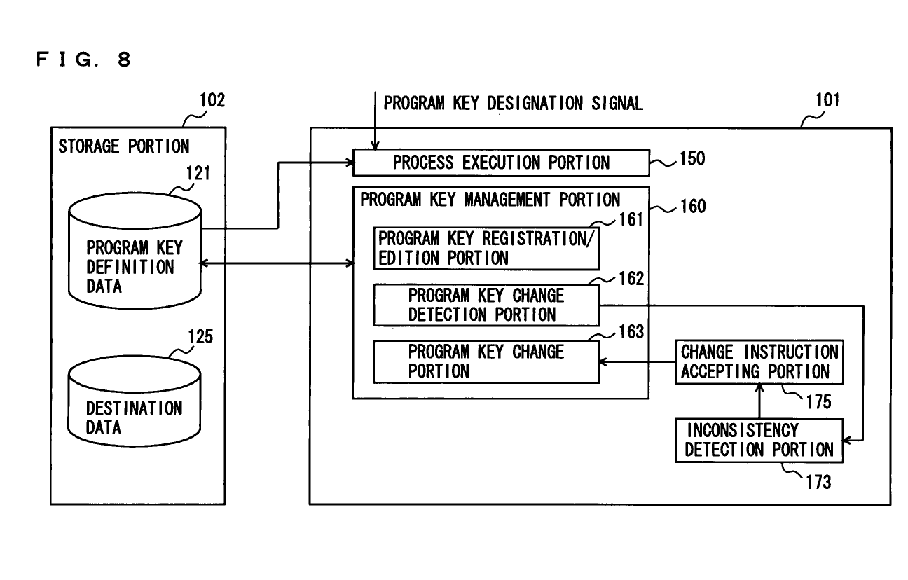

FIG. 8 is a functional block diagram showing an overall function of CPU included in MFP. Referring to FIG. 8, CPU 101 includes a process execution portion 150 for executing a process according to program key definition data 121 stored in storage portion 102, a program key management portion 160 for managing program key definition data 121 stored in storage portion 102, an inconsistency detection portion 173 detecting program key definition data including an inconsistent, defined process, and a change instruction accepting portion 175 for accepting an instruction to change the program key definition data including an inconsistent, defined process.

Program key management portion 160 includes a program key registration/edition portion 161 for registering and editing program key definition data, a program key change detection portion 162 for detecting that program key definition data has been changed, and a program key change portion 163 for changing program key definition data.

Program key registration/edition portion 161 causes a program key registration/edition window for registering and editing program key definition data to appear on display portion 109B. In registration, the user operates input portion 109A to input program key definition data, so that input portion 109A accepts the input program key definition data, and program key registration/edition portion 161 obtains the program key definition data from input portion 109A. On the other hand, in editing, the user operates input portion 109A to input a change of program key definition data, so that input portion 109A accepts the changed program key definition data, and program key registration/edition portion 161 obtains the changed program key definition data from input portion 109A. A change of program key definition data includes a change of a parameter corresponding to the output process. Furthermore, if the output process refers to destination data 125, a change of program key definition data includes a change of a parameter that refers to destination data 125. In registration, program key registration/edition portion 161 stores the obtained program key definition data into storage portion 102. Thus, program key definition data 121 is stored in storage portion 102. Program key registration/edition portion 161 may receive program key definition data 121 from a computer connected through network I/F 107 or modem 108 for storage into storage portion 102. Alternatively, program key registration/edition portion 161 may read program key definition data 121 stored in IC card 110A for storage into storage portion 102. In editing, program key registration/edition portion 161 updates program key definition data 121 stored in storage portion 102 to the changed program key definition data and also outputs the key No. for specifying the changed program key definition data to program key change detection portion 162.

Program key change detection portion 162 detects a change in program key definition data 121 stored in storage portion 102. At the time when program key definition data is updated by program key registration/edition portion 161, program key change detection portion 162 receives the key No. for specifying that program key definition data from program key registration/edition portion 161. When receiving the key No. for specifying the changed program key definition data 121 from program key registration/edition portion 161, program key change detection portion 162 outputs that key No. to inconsistency detection portion 173. Program key change detection portion 162 detects a change of a parameter corresponding to the output process of the program key definition data, for example, of the destination data that is referred to.

Inconsistency detection portion 173 determines whether or not a parameter corresponding to the process other than the output method is inconsistent with the output method of the output process defined by program key definition data 121 input from program key change detection portion 162. Inconsistency detection portion 173 stores beforehand a parameter which corresponds to the process other than the output process and which is consistent with each of the output methods. For example, if the output method is an output method other than facsimile transmission, a parameter corresponding to the image reading process shown in FIG. 4A is stored by default. On the other hand, if the output method is facsimile transmission, a parameter corresponding to the image reading process shown in FIG. 4B is stored by default. Inconsistency detection portion 173 compares the parameter corresponding to the process other than the output process defined by program key definition data 121 with the parameter stored beforehand which is consistent with the output process defined by program key definition data 121. In comparison, the kinds of parameters (items) may be compared, or the parameter itself may be compared. If they disagree with each other as a result of comparison, inconsistency detection portion 173 outputs program key definition data 121 and data indicating that the parameter is inconsistent, to change instruction accepting portion 175.

Upon reception of data indicating that parameter is inconsistent, change instruction accepting portion 175 causes a change instruction window for selecting a mode for changing a program key to appear on display portion 109B. When the user operates input portion 109A to select a change mode, input portion 109A accepts the selected change mode, and change instruction accepting portion 175 obtains the change mode from input portion 109A. Change instruction accepting portion 175 outputs a change instruction according to the obtained change mode to program key change portion 163. The change mode includes (1) automatic correction mode (2) simple manual correction mode and (3) detailed manual correction mode.

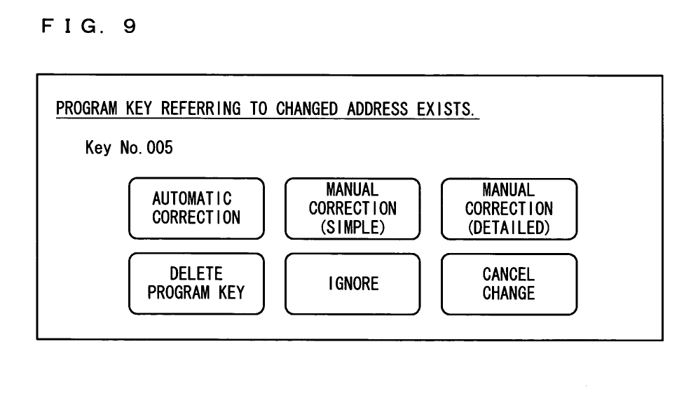

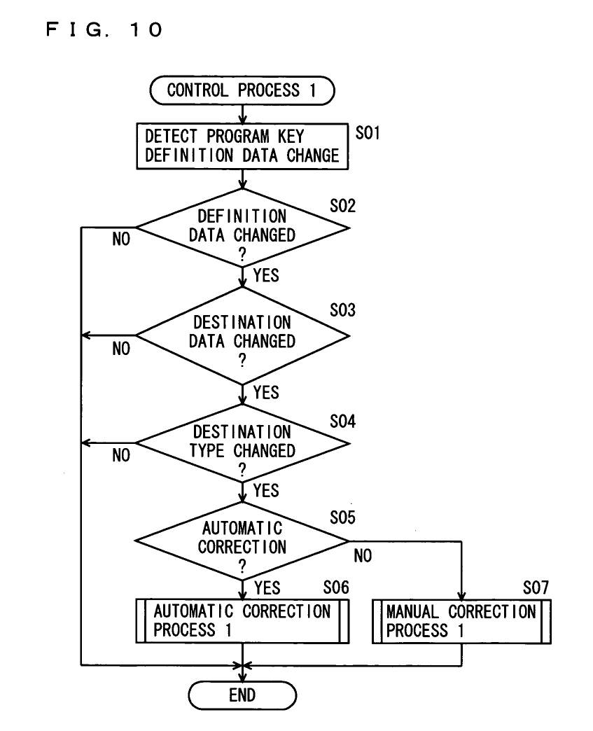

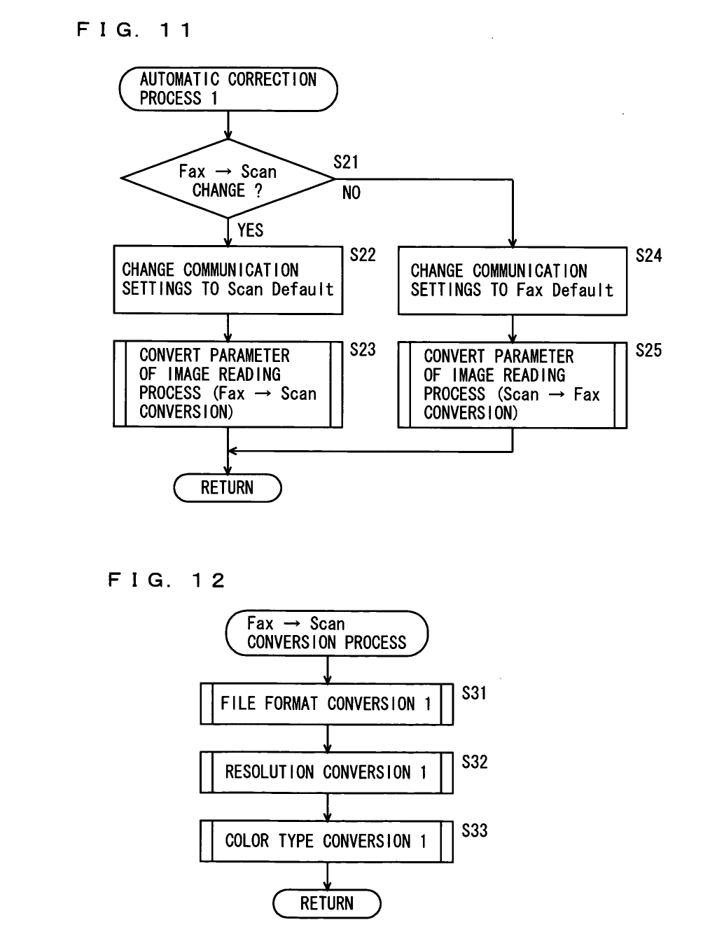

FIG. 9 is a diagram showing an exemplary change instruction window. Referring to FIG. 9, the change instruction window includes an “automatic correction” button for selecting the automatic correction mode, a “manual correction (simple)” button for selecting the simple manual correction mode, a “manual correction (detailed)” button for selecting the detailed manual correction mode, a “program key deletion” button for giving an instruction to delete a program key, an “ignore” button for cancelling the display of the selection window without executing any process, and a “change cancel” button for cancelling the change operation halfway to cancel the display of the selection window.

Returning to FIG. 8, when the automatic correction mode is selected, change instruction accepting portion 175 outputs an instruction to automatically correct program key definition data 121 to program key change portion 163. When the simple manual correction mode is selected, change instruction accepting portion 175 outputs program key definition data 121 to program key change portion 163 and receives information that specifies a parameter requiring correction from program key definition data 121. Change instruction accepting portion 175 causes a partial change window for changing a parameter requiring correction to appear on display portion 109B. When the user operates input portion 109A to input a changed parameter, input portion 109A accepts the changed parameter, and change instruction accepting portion 175 obtains the changed parameter from input portion 109A. Change instruction accepting portion 175 outputs the obtained changed parameter to program key change portion 163. When the detailed manual correction mode is selected, change instruction accepting portion 175 causes a change window to appear on display potion 109B to allow all of the program key definition data to be changed. Here, change instruction accepting portion 175 displays a parameter requiring correction and a parameter not requiring correction in different manners. For example, a parameter requiring correction is emphasized in such a manner that it is displayed with a line having a different thickness, displayed in a different color, or displayed in a different brightness. Therefore, the user can be aware of a parameter requiring correction. When the user operates input portion 109A to input a changed parameter, input portion 109A accepts the changed parameter, and change instruction accepting portion 175 obtains the changed parameter from input portion 109A. Change instruction accepting portion 175 outputs the obtained changed parameter to program key change portion 163.

In the automatic correction mode, upon reception of an instruction of automatic correction from change instruction accepting portion 175, program key change portion 163 changes a parameter corresponding to each process such that the parameter in program key definition data 121 to be processed becomes consistent with a plurality of processes. Specifically, program key change portion 163 changes the parameter corresponding to the process other than the output process such that it is consistent with the changed output process. A parameter corresponding to the process other than the output process may be stored beforehand in association with each of a plurality of output processes. Specifically, when a data transmission process and output destination information are defined as an output process by program key definition data 121, if the defined data transmission process is changed, program key change portion 163 changes a parameter corresponding to the process other than the output process such that it is consistent with the changed data transmission process. Program key change portion 163 stores a parameter corresponding to the process other than the output process beforehand in association with each of a plurality of data transmission processes in order to decide on a parameter after change. Here, program key change portion 163 stores a parameter corresponding to the image reading process by default in association with each of the facsimile transmission process and the process other than the facsimile transmission. In addition, when data processing and a file format are defined as the output process by program key definition data 121, if the defined output process is changed, program key change portion 163 changes a parameter corresponding to the process other than the output process such that the changed data processing is consistent with the processible file format. Program key change portion 163 stores a parameter by default for each process other than the output process in association with the data file format in order to decide on a parameter after change. Here, program key change portion 163 stores a parameter by default corresponding to the image reading process in association with the data file format.

When the parameter corresponding to the output process defined by program key definition data 121 refers to destination data 125, program key change portion 163 specifies destination data 125 based on that parameter. Program key change portion 163 changes the parameter corresponding to the process other than the output process such that it is consistent with the output method defined by the specified destination data. In addition, when the output method defined by the specified destination data 125 is “human designated transmission,” program key change portion 163 specifies a home terminal based on user identification information and obtains user information from the specified home terminal. Then, program key change portion 163 specifies an output method based on the obtained user information and changes the parameter corresponding to the process other than the output process such that it is consistent with the specified output method.

In the simple correction mode, program key change portion 163 specifies a parameter requiring correction from program key definition data 121. Specifically, similarly to the automatic correction mode, program key change portion 163 changes a parameter corresponding to each process such that the parameter of program key definition data 121 to be processed is consistent with a plurality of processes. A parameter that is different between after change and before change is determined as a parameter requiring correction. Program key change portion 163 outputs to change instruction accepting portion 175 information that specifies a parameter requiring correction in program key definition data 121 input from change instruction accepting portion 175. In the simple correction mode or the detailed correction mode, upon reception of the changed program key definition data 121 from change instruction accepting portion 175, program key change portion 163 stores the changed program key definition data 121 in storage portion 102.

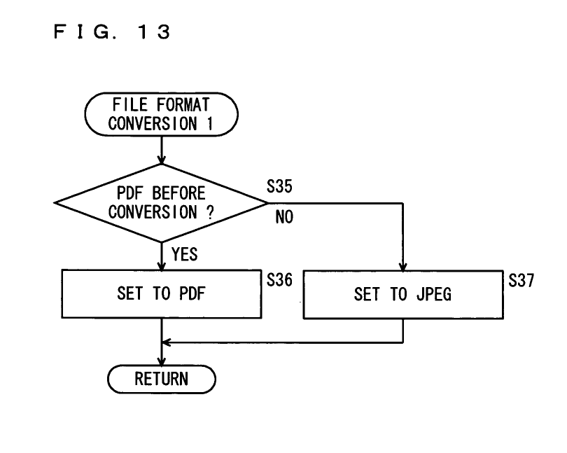

FIG. 10 is a flowchart illustrating an exemplary flow of a control process executed in MFP in accordance with the present embodiment. This control process is executed in CPU 101 by CPU 101 of MFP 100 loading and executing the control program stored in ROM of storage portion 102. Desirably, this control process has an execution timing scheduled to start, for example, at a prescribed time once a day. However, it may start at irregular intervals upon the user's instruction. Referring to FIG. 10, CPU 101 detects a change of program key definition data 121 stored in storage portion 102 (step S01). It is noted that if a plurality of program key definition data are detected at step S01, the processes following step S02 are performed for each of a plurality of program key definition data 121. If a change of program key definition data 121 is detected (YES at step S02), the process proceeds to step S03. If a change is not detected (NO at step S02), the process ends. Then, it is determined whether or not the output process defined by the changed program key definition data 121 is changed (step S03). A change of the output process is a change of destination data 125 that is a parameter corresponding to the output process. In other words, a change of the program key definition data includes a change of the parameter corresponding to the output process. If a change of program key definition data 121 is detected, CPU 101 specifies the changed program key definition data 121 and proceeds to step S04. If a change of program key definition data 121 is not detected, the process ends. At step S04, CPU 101 determines whether or not the destination type of the destination data determined as being changed at step S03 is changed. The destination type refers to a type of an output method. A first destination type (referred to as “Fax type” hereinafter) is facsimile transmission and a second destination type (referred to as “Scan type” hereinafter) is email transmission, storage into HDD, SMB and FTP other than facsimile transmission. If the destination type is changed from Fax type to Scan type, or if the destination type is changed from Scan type to Fax type, CPU 101 proceeds to step S05, and if a destination type is not changed, the process ends.

At step S05, CPU 101 determines whether or not MFP 100 is set in the automatic correction mode. If set in the automatic correction mode, the process proceeds to step S06, and if not set in the automatic correction mode, the process proceeds to step S07. MFP 100 is set in the automatic correction mode by the user inputting in input portion 109A an instruction to set the automatic correction mode. CPU 101 executes an automatic correction process at step S06 and executes a manual correction mode at step S07. The automatic correction process and the manual correction process will be described later.

FIG. 11 is a flowchart illustrating an exemplary flow of the automatic correction process. The automatic correction process is a process executed at step S06 in FIG. 10. Referring to FIG. 11, CPU 101 determines whether or not the destination type is changed from Fax type to Scan type (step S21). If Fax type is changed to Scan type, the process proceeds to step S22, and if Scan type is changed to Fax type, the process proceeds to step S24. At step S22, the communication setting of the output method is changed to a default parameter (Scan Default) that is predetermined corresponding to Scan type. At the next step S23, a parameter corresponding to the image reading process is converted into a parameter corresponding to Scan type. This conversion process is referred to as Fax→Scan conversion process, which will be detailed later. At step S24, the communication setting of the output method is changed to a default parameter (Fax Default) that is predetermined corresponding to Fax type. At the next step S25, a parameter corresponding to the image reading process is converted into a parameter corresponding to Fax type. This conversion process is referred to as Scan→Fax conversion process, which will be detailed later.

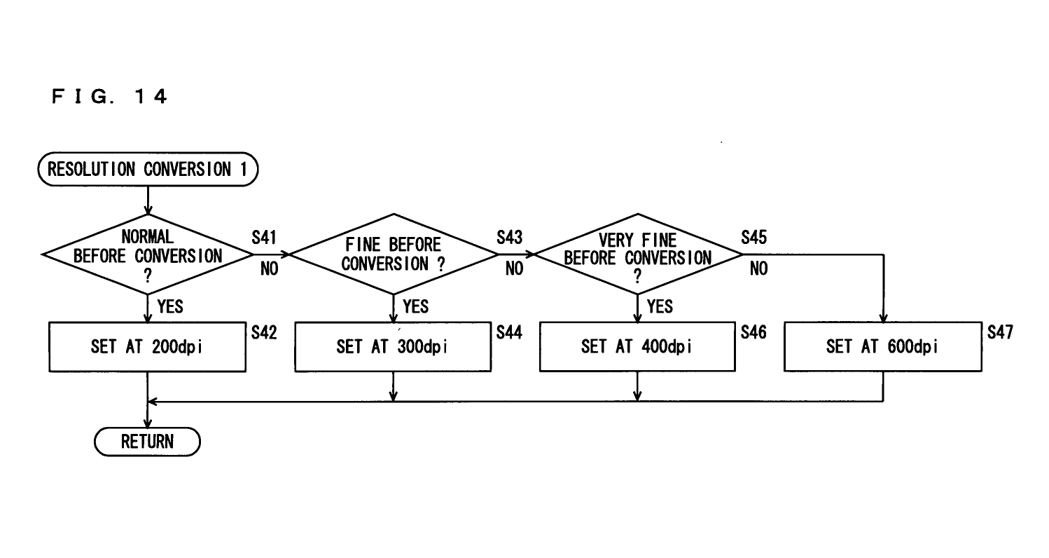

FIG. 12 is a flowchart illustrating an exemplary flow of Fax Scan conversion process. Fax→Scan conversion process is a process executed at step S24 in FIG. 11. Referring to FIG. 12, CPU 101 executes a file format conversion process of converting a parameter of a file format (step S31), a resolution conversion process of converting a parameter of resolution (step S32) and a color type conversion process of converting a parameter of a color type (step S33), and thereafter returns to the automatic correction process. It is noted that in each conversion process included in FIG. 12, among parameters that can be set in the case of facsimile transmission as shown in FIG. 4B, those included in the parameters that can be set in the case other than fax transmission as shown in FIG. 4A are changed to corresponding parameters as they are, and those not included are changed to underlined parameters which are default setting values in those settings. In the color type change process, however, the parameter is changed to “auto” in order to be flexibly adapted to a document type.

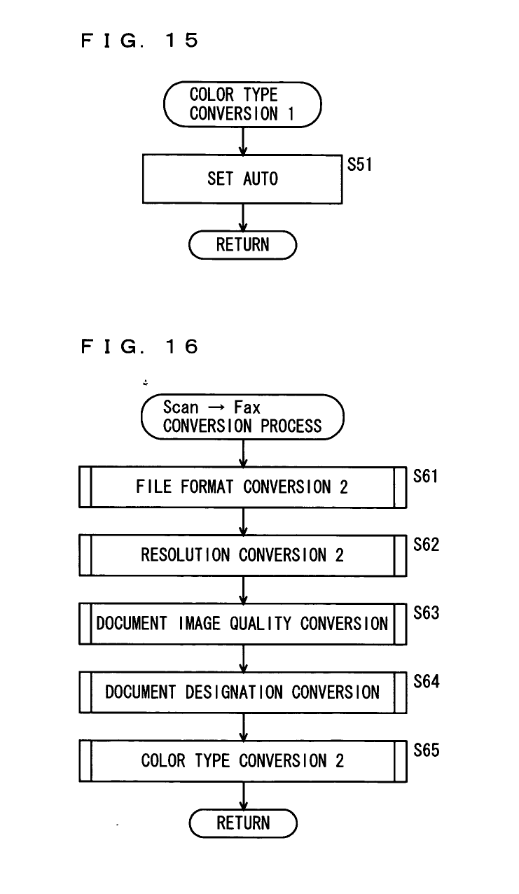

FIG. 13 is a diagram illustrating an exemplary flow of the file format conversion process executed at step S31 in FIG. 12. Referring to FIG. 13, CPU 101 determines whether or not the parameter of the file format before conversion is PDF (Portable Document Format) (step S35). If PDF, the process proceeds to step S36, and if not PDF, the process proceeds to step S37. CPU 101 sets the parameter of the file format to PDF at step S36, and sets the parameter of the file format to JPEG at step S37 and thereafter returns to Fax→Scan conversion process. As a result of such a file format conversion, settings can be made in such a manner that inconsistency is not caused at the time of execution of a job while the original settings are respected.

FIG. 14 is a diagram illustrating an exemplary flow of the resolution conversion process executed at step S32 in FIG. 12. Referring to FIG. 14, CPU 101 determines whether or not the parameter of resolution before conversion is normal or not (step S41). If normal, the process proceeds to step S42, and if not normal, the process proceeds to step S43. At step S42, CPU 101 sets the parameter of resolution at 200 dpi and then returns to Fax Scan conversion process. At step S43, CPU 101 determines whether or not the parameter of resolution before conversion is fine. If fine, the process proceeds to step S44 and if not fine, the process proceeds to step S45. At step S44, CPU 101 sets the parameter of resolution at 300 dpi and then returns to Fax→Scan conversion process. At step S45, CPU 101 determines whether or not the parameter of resolution is very fine. If very fine, the process proceeds to step S46, and if not very fine, the process proceeds to step S47. At step S46, CPU 101 sets the parameter of resolution at 400 dpi and then returns to Fax→Scan conversion process. If the process proceeds to step S47, the parameter of resolution before conversion is super fine. Therefore, at step S47, CPU 101 sets the parameter of resolution at 600 dpi and then returns to Fax Scan conversion process. As a result of such conversion, the setting items which are different between Fax and Scan can be converted into approximately the equivalent settings.

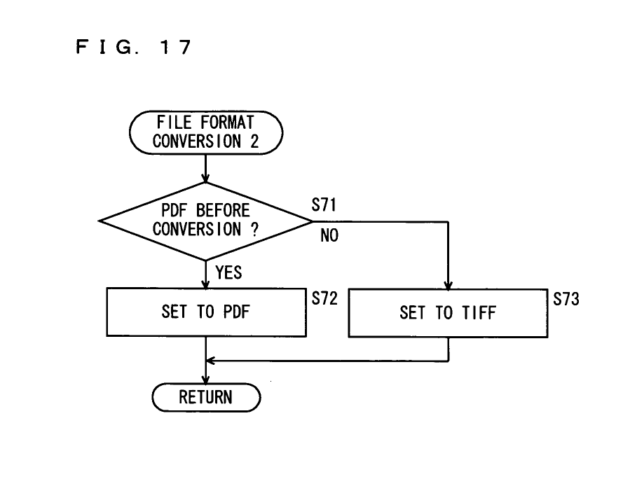

FIG. 15 is a diagram illustrating an exemplary flow of the color type conversion process executed at step S33 in FIG. 12. Referring to FIG. 15, CPU 101 sets the parameter of color type conversion to the auto (step S51) and thereafter returns to Fax→Scan conversion process. As a result of such conversion, inconsistency is not caused at the time of execution of a job with more flexible settings.

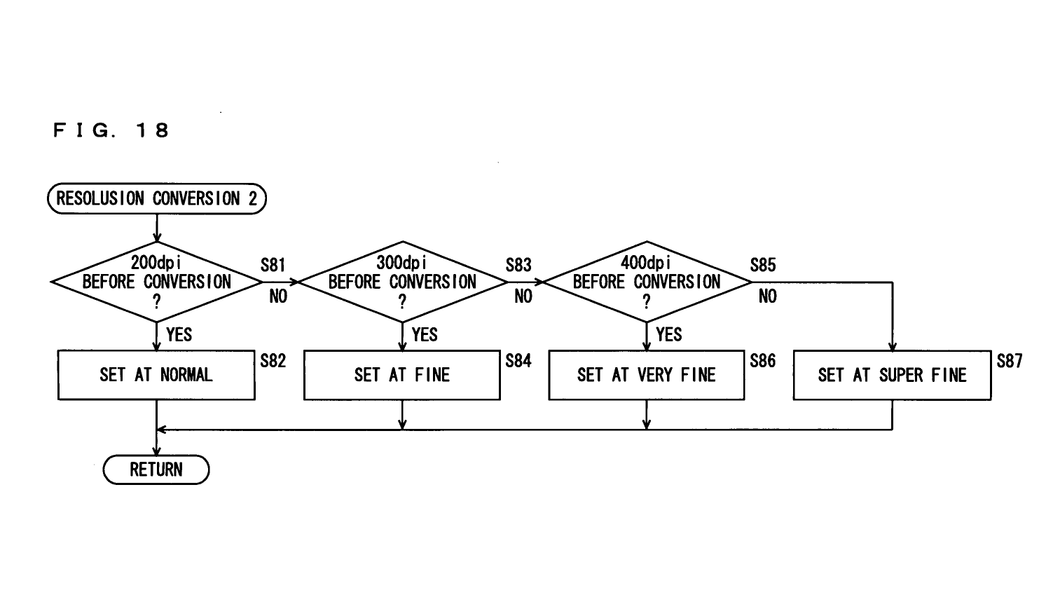

FIG. 16 is a flowchart illustrating an exemplary flow of Scan Fax conversion process. Scan→Fax conversion process is a process executed at step S25 in FIG. 11. Referring to FIG. 16, CPU 101 executes a file format conversion process of converting a parameter of a file format (step S61), a resolution conversion process of converting a parameter of resolution (step S62), a document image quality conversion process of converting a parameter of document image quality (step S63), a document designation conversion process of changing a parameter of document designation (step S64), and a color type conversion process of converting a parameter of color type (step S65), and thereafter returns to the automatic correction process. It is noted that in each conversion process included in FIG. 16, among the parameters that can be set in the case other than fax transmission as shown in FIG. 4A, those included in the parameters that can be set in the case of facsimile transmission as shown in FIG. 4B are set as they are, and those not included are converted into the underlined default setting values.

FIG. 17 is a diagram illustrating an exemplary flow of the file format conversion process executed at step S61 in FIG. 16. Referring to FIG. 17, CPU 101 determines whether or not the parameter of the file format before conversion is PDF (step S71). If PDF, the process proceeds to step S72, and if not PDF, the process proceeds to step S73. CPU 101 sets the parameter of the file format to PDF at step S72, sets the parameter of the file format to TIFF (Tagged Image File Format) at step S73, and thereafter returns to Scan Fax conversion process.

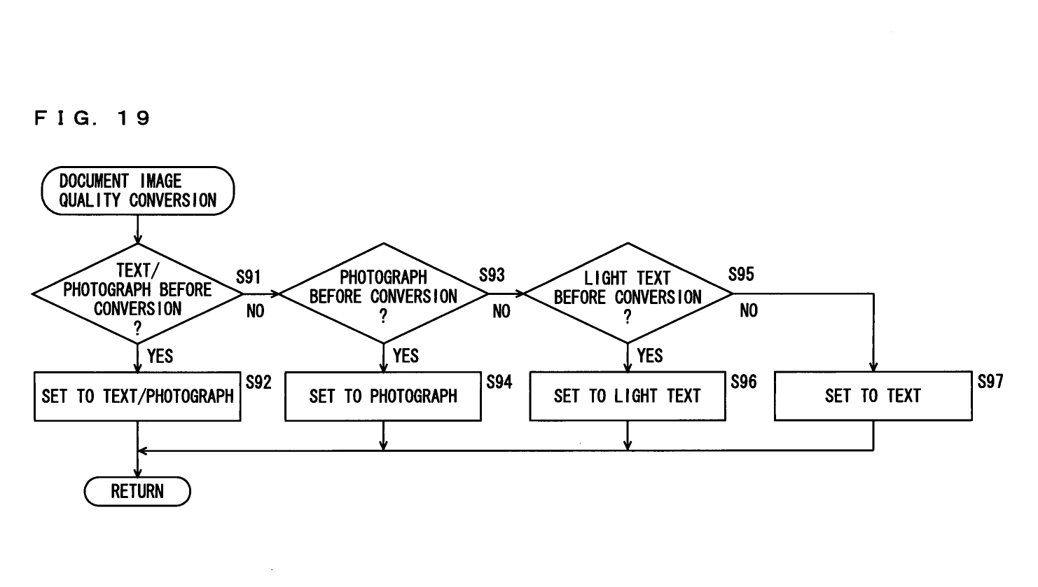

FIG. 18 is a diagram illustrating an exemplary flow of the resolution conversion process executed at step S62 in FIG. 16. Referring to FIG. 18, CPU 101 determines whether or not the parameter of resolution before conversion is 200 dpi (step S81). If 200 dpi, the process proceeds to step S82, and if not 200 dpi, the process proceeds to step S83. CPU 101 sets the parameter of resolution at normal at step S82 and thereafter returns to Scan→Fax conversion process. At step S83, CPU 101 determines whether or not the parameter of resolution before conversion is 300 dpi. If 300 dpi, the process proceeds to step S84, and if not 300 dpi, the process proceeds to step S85. CPU 101 sets the parameter of resolution to “fine” at step S84 and thereafter returns to Scan→Fax conversion process. At step S85, CPU 101 determines whether or not the parameter of resolution before conversion is 400 dpi. If 400 dpi, the process proceeds to step S86, and if not 400 dpi, the process proceeds to step S87. CPU 101 sets the parameter of resolution to “very fine” at step S86 and thereafter returns to Scan→Fax conversion process. When the process proceeds to step S87, the parameter of resolution before conversion is 600 dpi. Therefore, CPU 101 sets the parameter of resolution to “super fine” at step S87 and thereafter returns to Scan→Fax conversion process.

FIG. 19 is a diagram illustrating an exemplary flow of the document image quality conversion process executed at step S63 in FIG. 16. Referring to FIG. 19, CPU 101 determines whether or not the parameter of document image quality before conversion is text/photograph (step S91). If text/photograph, the process proceeds to step S92, and if not text/photograph, the process proceeds to step S93. CPU 101 sets the parameter of document image quality to text/photograph at step S92, and thereafter returns to Scan→Fax conversion process. At step S93, CPU 101 determines whether or not the parameter of document image quality before conversion is photograph. If photograph, the process proceeds to step S94, and if not photograph, the process proceeds to step S95. CPU 101 sets the parameter of document image quality to photograph at step S94 and thereafter returns to Scan→Fax conversion process. At step S95, CPU 101 determines whether or not the parameter of document image quality before conversion is light text. If light text, the process proceeds to step S96, and if not light text, the process proceeds to step S97. CPU 101 sets the parameter of document image quality to light text at step S96 and thereafter returns to Scan→Fax conversion process. When the process proceeds to step S97, the parameter of document image quality before conversion is any of text, map, or copy document. Therefore, CPU 101 sets the parameter of document image quality to text at step S97 and thereafter returns to Scan→Fax conversion process. As a result of such conversion, inconsistency at the time of execution of a job can be avoided while original settings are applied.

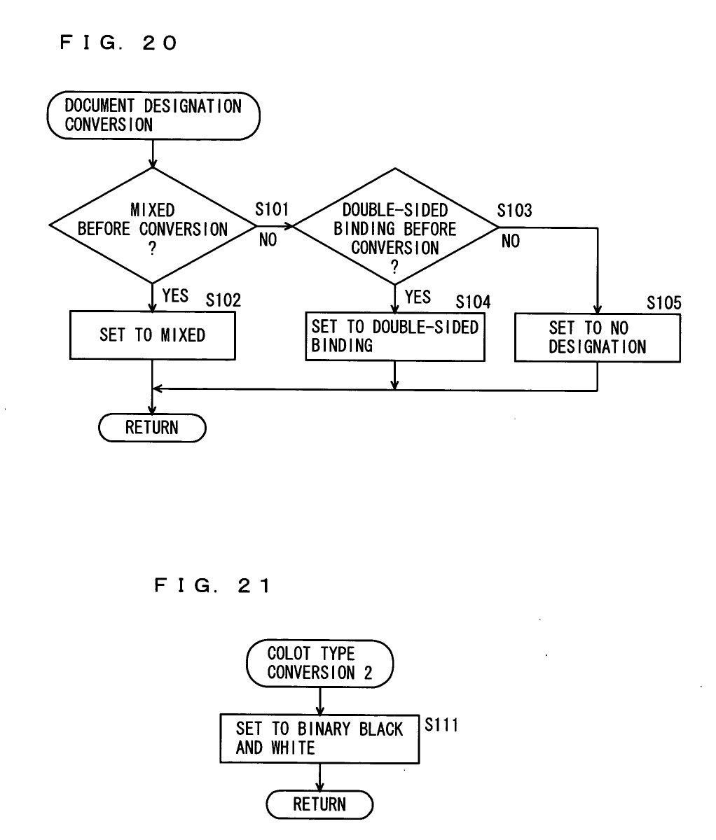

FIG. 20 is a diagram illustrating an exemplary flow of the document designation conversion process executed at step S64 in FIG. 16. Referring to FIG. 20, CPU 101 determines whether or not the parameter of document designation before conversion is mixed (step S101). If mixed, the process proceeds to step S102, and if not mixed, the process proceeds to step S103. CPU 101 sets the parameter of document designation to mixed at step S102 and thereafter returns to Scan→Fax conversion process. At step S103, CPU 101 determines whether or not the parameter of document designation before conversion is double-sided binding. If double-sided binding, the process proceeds to step S104, and if not double-sided binding, the process proceeds to step S105. CPU 101 sets the parameter of document designation to double-sided binding at step S104 and thereafter returns to Scan→Fax conversion process. When the process proceeds to step S105, the parameter of document designation before conversion is any of no designation, heavy paper, and document set direction. Therefore, CPU 101 sets the parameter of document designation to no designation at step S105 and thereafter returns to Scan→Fax conversion process. As a result of such conversion, inconsistency at the time of execution of a job can be avoided while original settings are applied.

FIG. 21 is a diagram illustrating an exemplary flow of the color type conversion process executed at step S65 in FIG. 16. Referring to FIG. 21, CPU 101 sets the parameter of the color type conversion to binary black and white (step S111) and thereafter returns to Scan→Fax conversion process.

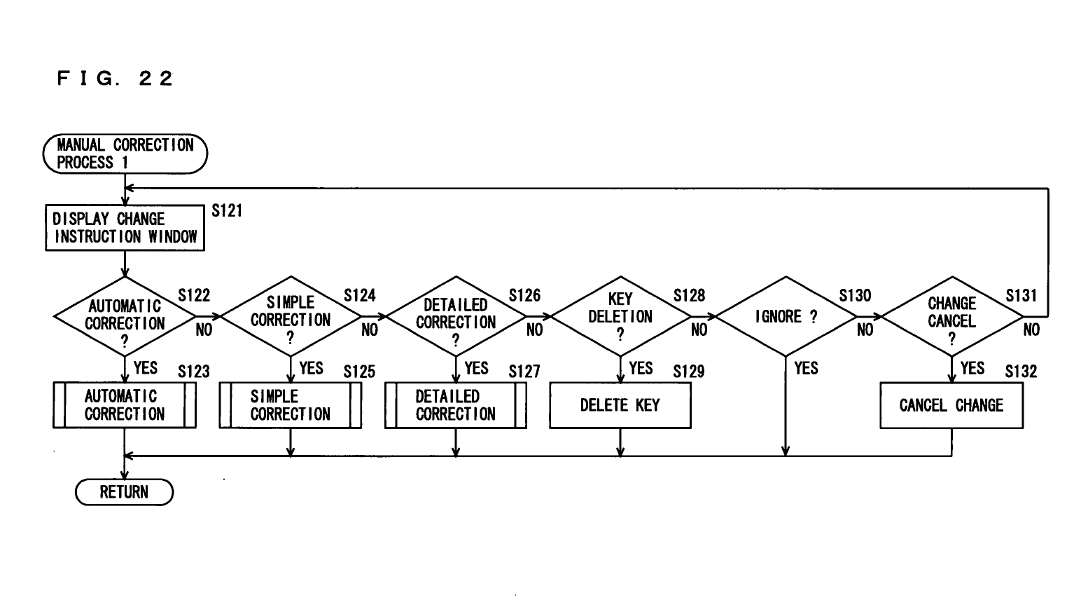

FIG. 22 is a flowchart illustrating an exemplary flow of the manual correction process. The manual correction process is a process executed at step S07 in FIG. 10. Referring to FIG. 22, CPU 101 causes the change instruction window shown in FIG. 9 to appear on display portion 109B (step S121). The user inputs a selection instruction to input portion 109A, so that CPU 101 obtains the selection instruction input to input portion 109A. At step S122, CPU 101 determines whether or not the selection instruction is automatic correction. If automatic correction, the process proceeds to step S123, and if not automatic correction, the process proceeds to step S124. At step S123, CPU 101 executes the automatic correction process shown in FIG. 11. At step S124, CPU 101 determines whether or not the selection instruction is simple correction. If simple correction, the process proceeds to step S125, and if not simple correction, the process proceeds to step S126. At step S125, CPU 101 executes a simple correction process, which will be described later. At step S126, CPU 101 determines whether or not the selection instruction is detailed correction. If detailed correction, the process proceeds to step S137, and if not detailed correction, the process proceeds to step S128. At step 127, CPU 101 executes a detailed correction process, which will be described later. In addition, at step S128, CPU 101 determines whether or not the selection instruction is program key deletion. If program key deletion, the process proceeds to step S129, and if not program key deletion, the process proceeds to step S130. At step S129, CPU 101 deletes program key definition data 121 to be changed from storage portion 102. At step S130, CPU 101 determines whether or not the selection instruction is to ignore. If the selection instruction is to ignore, CPU 101 ends the process, and if not to ignore, the process proceeds to step S131. At step S131, CPU 101 determines whether or not the selection instruction is to cancel a change. If the selection instruction is to cancel a change, CPU 101 proceeds to step S132, and it not to cancel a change, the process returns to step S121. At step S132, CPU 101 cancels changing data. Specifically, when the program key definition data is changed, the program key definition data is returned to the state before change. If the destination data has been changed, the destination data is returned to the state before change. If the function BOX process definition data has been changed, the function BOX process definition data is returned to the state before change. This can prevent inconsistency of parameters defined by the program key definition data.

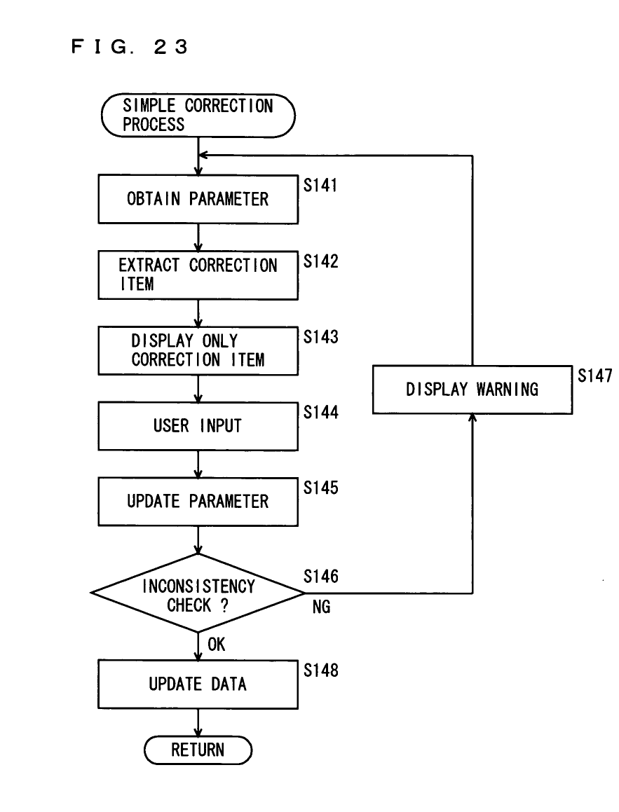

FIG. 23 is a flowchart illustrating an exemplary flow of the simple correction process. Referring to FIG. 23, CPU 101 obtains a parameter of program key definition data 121 to be processed (step S141). Then, CPU 101 extracts a correction item (step S142). CPU 101 changes a parameter corresponding to each process such that the parameter of program key definition data 121 to be processed is consistent with a plurality of processes. CPU 101 determines that a parameter that is different between after change and before change is a parameter requiring correction, and then extracts that parameter as a correction item. CPU 101 causes the parameter extracted at step S142 as a correction item to appear on display portion 109B (step S143). Then, CPU 101 accepts an input of a changed parameter from the user (step S144). At step S145, CPU 101 changes the parameter of program key definition data 121 to the changed parameter accepted at step S144. Then, it is determined whether or not there is inconsistency in the parameter (step S146). If there is no inconsistency, the process proceeds to step S148, and if there is inconsistency, the process proceeds to step S147. At step S147, CPU 101 causes a warning window including a warning message to appear on display portion 109B to indicate that the parameter is not consistent (step S147) and then returns to step S141. At step S148, CPU 101 updates the program key definition data by changing the parameter of the program key definition data to the changed parameter (step S148).

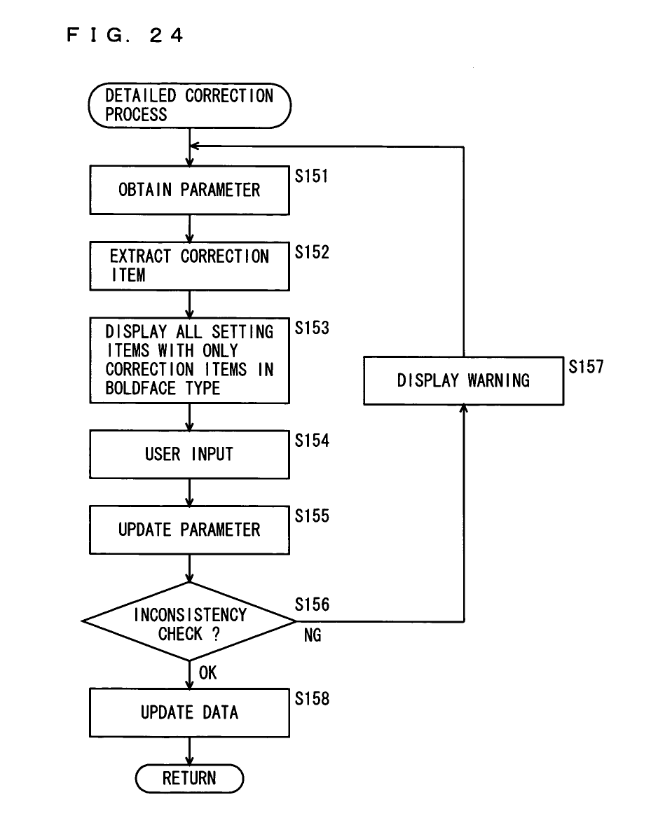

FIG. 24 is a flowchart illustrating an exemplary flow of the detailed correction process. Referring to FIG. 24, CPU 101 obtains the parameter of program key definition data 121 to be processed (step S151). Then, CPU 101 extracts a correction item (step S152). CPU 101 displays all the parameters of the program key definition data on display portion 109B (step S153). In this display, CPU 101 displays the parameter extracted at step S152 as a correction item in a manner different from the characters representing the parameters of the other items. For example, the parameter of the correction item is displayed in a boldface type or the like for emphasis. The processes at step S154-S158 are the same as the processes at step S144-step S148 shown in FIG. 23 and therefore description thereof will not be repeated here.

As described above, MFP 100 in accordance with the present embodiment includes storage portion 102 storing program key definition data 121 that defines an image reading process and an output process, process execution portion 150 reading program key definition data 121 from storage portion 102 to execute the image reading process and the output process defined by program key definition data 121, program key change detection portion 162 detecting that the output process defined by the stored program key definition data is changed, and program key change portion 163 changing the image reading process defined by the changed program key definition data 121. Therefore, even after a change of a process, a plurality of series of processes are executed appropriately and no longer disabled. Thus, a process can easily be changed.

Furthermore, storage portion 102 stores destination data 125 that defines an output method and output destination information for specifying an output destination. The output process of the program key definition data is associated with the parameter that refers to destination data 125. Process execution portion 150 outputs data to an output destination in an output method defined by destination data 125 that is referred to by the parameter corresponding to the output process. When a parameter that refers to destination data 125 in the program key definition data is changed by program key registration/edition portion 161, that part of program key definition data 121 which defines the output process is changed, so that program key change portion 163 changes the image reading process. Therefore, data can be output in an output method after the parameter that refers to destination data 125 in the program key definition data is changed.

<Modification>

In MFP 100 as described above, when the output process defined by program key definition data is changed, the program key definition data is changed such that the changed program key definition data is executable. In MFP 100 in the modification, when destination data is changed, all of program key definition data that refer to that destination data are extracted, and those of all of the extracted program key definition data which are not executable are changed to be executable. In the following, differences from the aforementioned MFP 100 will mainly be described.

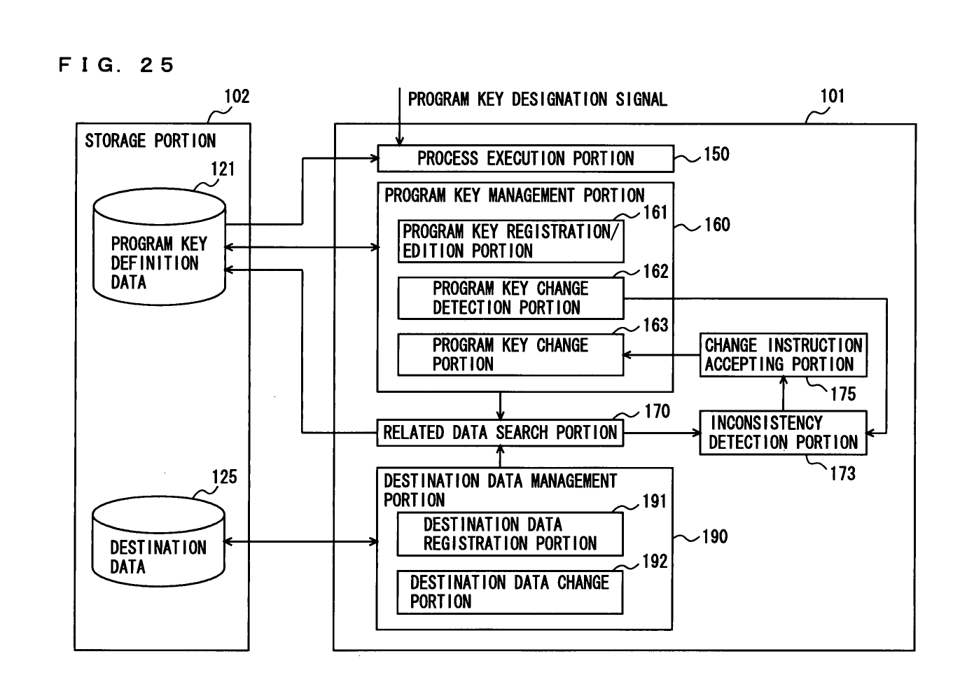

FIG. 25 is a functional block diagram schematically showing a function of CPU included in MFP in the modification. FIG. 25 differs from the functional block diagram shown in FIG. 8 in that CPU 101 further includes a destination data management portion 190 for managing destination data 125 stored in storage portion 102 and a related data search portion 170 searching program key definition data 121.

Destination data management portion 190 includes a destination data registration portion 191 for registering destination data and a destination data change portion 192 for changing destination data. Destination data registration portion 191 causes a destination data registration window to appear on display portion 109B for registering destination data. The user operates input portion 109A to input destination data, so that input portion 109A accepts the input destination data, and destination data registration portion 191 obtains the destination data from input portion 109A. Destination data registration portion 191 stores the obtained destination data into storage portion 102. Thus, destination data 125 is stored in storage portion 102. It is noted that destination data registration portion 191 may receive destination data 125 from a computer connected through network I/F 107 or modem 108 for storage into storage portion 102. Alternatively, destination data registration portion 191 may read destination data 125 stored in IC card 110A for storage into storage portion 102.

Destination data change portion 192 causes a destination data edition window to appear on display portion 109B for editing destination data. The user operates input portion 109A to input data to change the contents of destination data 125, so that input portion 109A accepts the changed destination data 125, and destination data change portion 192 obtains the changed destination data 125 from input portion 109A. Destination data change portion 192 stores the changed destination data 125 into storage portion 102 and also outputs the destination No. for identifying the changed destination data 125 to related data search portion 170.

On the other hand, when an output method of user information is changed, a home terminal transmits the changed user information to all the other MFPs including MFP 100. Upon reception of the changed user information from the home terminal, destination data change portion 192 extracts destination data 125 that includes the received user information in output destination information and has the output method set to human designated transmission, from destination data 125 stored in storage portion 102, and then outputs the destination No. for identifying the extracted destination data 125 to related data search portion 170.

Related data search portion 170 receives the destination No. for specifying the changed destination data 125 from destination data change portion 192. Related data search portion 170 searches program key definition data 121 stored in storage portion 102 to extract program key definition data 121 that refers to the changed destination data 125, and outputs the extracted program key definition data 121 to inconsistency detection portion 173. Specifically, related data search portion 170 receives the destination No. for specifying the changed destination data 125 to extract program key definition data 121 that defines the received destination No. from program key definition data 121 stored in storage portion 102.

Inconsistency detection portion 173 determines whether or not the parameter corresponding to the process other than the output method is consistent with the output method of the output process defined by program key definition data 121 input from related data search portion 170. If it is determined that the parameter is not consistent, inconsistency detection portion 173 outputs that program key definition data 121 and data indicating that the parameter is not consistent to change instruction accepting portion 175.

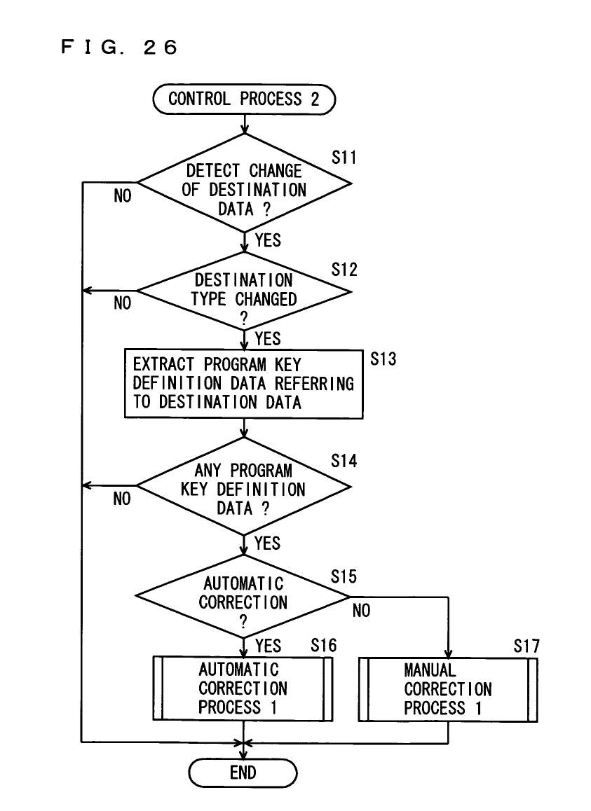

FIG. 26 is a second flowchart illustrating an exemplary flow of a control process executed in MFP in the modification. Referring to FIG. 26, CPU 101 detects a change of destination data 125 stored in storage portion 102 (step S11). If a change of the destination data is detected, the process proceeds to step S12, and if not detected, the process ends. At step S12, it is determined whether or not the destination type of destination data 125 detected at step S11 is changed. The destination type refers to a type of an output method. A first destination type (referred to as “Fax type” hereinafter) is facsimile transmission. A second destination type (referred to as “Scan type” hereinafter) is email transmission, storage into HDD, SMB, and FTP, other than facsimile transmission. If the destination type is changed from Fax type to Scan type, or if the destination type is changed from Scan type to Fax type, CPU 101 proceeds to step S13. If the destination type is not changed, the process then ends.

At step S13, all of program definition data 121 that refer to destination data 125 detected at step S11 are extracted from program key definition data 121 stored in storage portion 102. At step S14, it is determined whether or not program key definition data 121 is extracted at step S13. If any program key definition data 121 is extracted, the process proceeds to step S15, and if none is extracted, the process ends. The processes at step S15-step S17 are the same as step S05-step S07 shown in FIG. 10, respectively, and therefore description thereof will not be repeated here. If a plurality of program key definition data 121 are extracted at step S13, the processes at step S15-step S17 are performed on each of the extracted plurality of program key definition data 121.

In this way, MFP 100 in the modification includes: storage portion 102 storing program key definition data 121 defining an image reading process and an output process and destination data 125 related with program key definition data 121 and defining the output process; process execution portion 150 reading program key definition data 121 from storage portion 102 to execute the image reading process and the output process defined by program key definition data 121; destination data change portion 192 detecting a change of destination data 125; and program key change portion 163 changing program key definition data 121 related with destination data 125 according to the change of destination data 125. Therefore, when destination data 125 is changed, program key definition data 121 related with destination data 125 is changed, so that a part of the settings for executing the image reading process and the output process defined by program key definition data 121 can easily be changed.

### Second Embodiment

MFP 100 in accordance with a second embodiment includes a function BOX in storage portion 102 in addition to the functions of MFP 100 in the first embodiment. In the following, differences from MFP 100 in the first embodiment will mainly be described.

Storage portion 102 includes HDD. HDD of storage portion 102 has its storage region divided into a plurality of regions. Each of the plurality of regions is called BOX. Of a plurality of BOX, the function BOX is a BOX related with a function BOX process. The function BOX process is defined by function BOX process definition data. The function BOX process definition data is data related with the function BOX held by HDD included in storage portion 102. When data is stored in the region allocated to the function BOX of HDD of storage portion 102, MFP 100 reads the function BOX process definition data related with the function BOX and executes a process defined by the function BOX process definition data where the data stored in the function BOX is data to be processed.

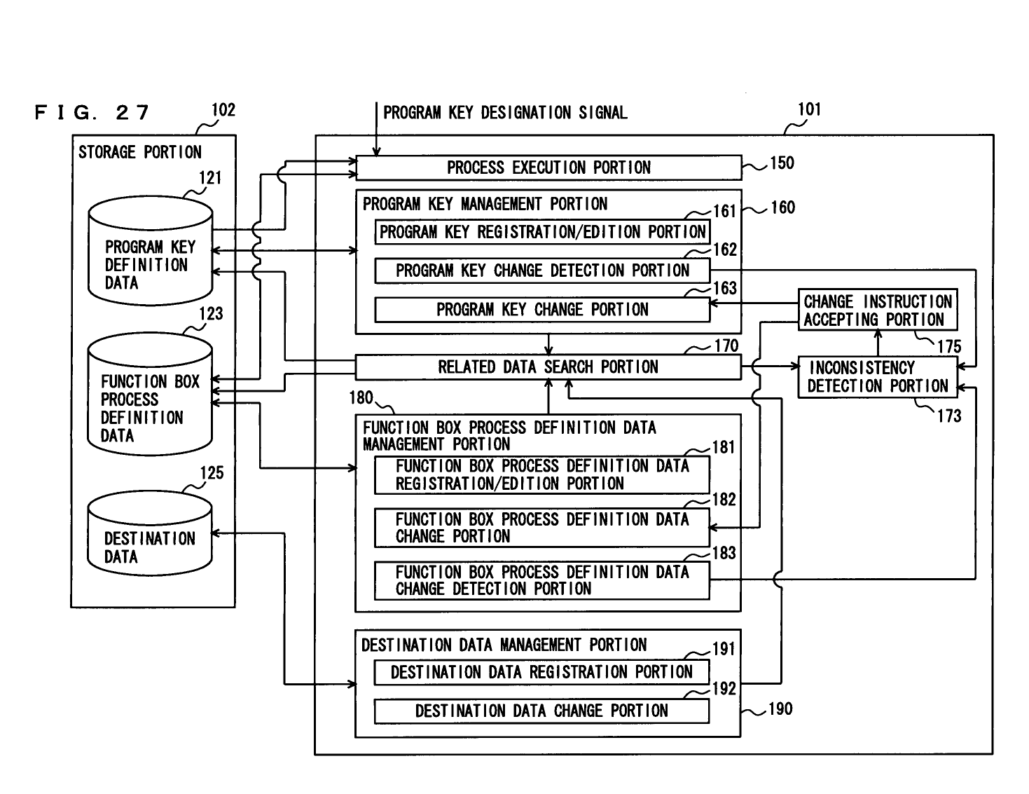

FIG. 27 is a functional block diagram schematically showing a function of CPU included in MFP in accordance with the second embodiment. FIG. 27 differs from the functional block diagram shown in FIG. 25 in that HDD 102 further includes function BOX process definition data 123 and that CPU 101 further includes a function BOX process definition data management portion 180 for managing function BOX process definition data 123 stored in storage portion 102.

Program key registration/edition portion 161 obtains the changed program key definition data from input portion 109A, where the change of the program key definition data includes a change of the parameter corresponding to the output process. The parameter corresponding to the output process includes an output process. If the output process refers to a function BOX, a change of program key definition data includes a change of the parameter that refers to the function BOX.

Program key change detection portion 162 detects a change of the parameter corresponding to the output process of program key definition data, for example, a change of destination data that is referred to or a change of the function BOX No. that is referred to.

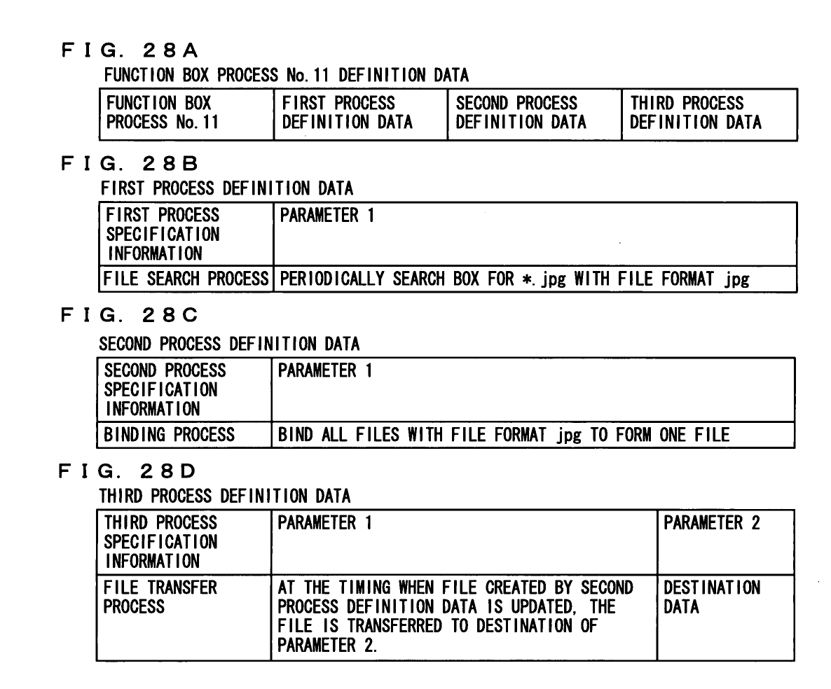

Here, the function BOX process definition data will be described. FIGS. 28A-28D are diagrams illustrating formats of the function BOX process definition data. Referring to FIG. 28A, the function BOX process definition data relates a function BOX process No. for identifying a function BOX and function BOX process definition data with process definition data that defines at least one process. In the figure, the first process definition data to the third process definition data are related with each other. FIG. 28B is a diagram illustrating exemplary first process definition data defined by the function BOX process definition data. The first process definition data defines first process specification information for specifying a process and a parameter 1 required to execute the process specified by the first process specification information. The first process specification information defines “file search process,” and parameter 1 defines “periodically search BOX for *.jpn whose file format is jpn.” Since the function BOX process definition data defines “file search process” in the first process specification information, CPU 101 periodically performs a process of searching data stored in the BOX of the function BOX No. 11 for all the files having the file format JPEG.

FIG. 28C is a diagram showing exemplary second process definition data defined by the function BOX process definition data. The second process definition data defines second process specification information for specifying a process and a parameter 1 required to execute a process specified by the second process specification information. The second process specification information defines “binding process,” and parameter 1 defines that “all the files having the file format jpg are bound together to form one file.” Since the function BOX process definition data defines “binding process” in the second process specification information, CPU 101 performs a process of binding the files that are searched for and extracted according to the first process definition data, to form one file.

FIG. 28D is a diagram showing exemplary third process definition data defined by the function BOX process definition data. The third process definition data defines third process specification information for specifying a process and a parameter 1 required to execute a process specified by the third process specification information. The third process specification information defines “file transfer process,” parameter 1 defines that “at the timing when a file created by the second process definition data is updated, that file is transferred to the destination of parameter 2,” and parameter 2 defines “destination data.” Since the function BOX process definition data defines “file transfer process” in the third process specification information, CPU 101 creates a file according to the second process definition data and transmits the file to the destination data defined by parameter 2.

Returning to FIG. 27, when the parameter corresponding to the output process defined by program key definition data 121 refers to a function BOX, program key change portion 163 specifies function BOX process definition data 123 related with the function BOX based on that parameter. Program key change portion 163 changes the parameter corresponding to the process other than the output process such that it is consistent with at least one process defined by the specified function BOX process definition data 123.

Function BOX process definition data management portion 180 includes a function BOX process definition data registration/edition portion 181 for registering and editing the function BOX process definition data, a function BOX process definition data change detection portion 183 for detecting that the function BOX process definition data is changed, and a function BOX process definition data change portion 182 for changing the function BOX process definition data.

Function BOX process definition data registration/edition portion 181 causes a function BOX process definition data registration/edition window to appear on display portion 109B to register and edit the function BOX process definition data. In registration, the user operates input portion 109A to input function BOX process definition data, so that input portion 109A accepts the input function BOX process definition data, and function BOX process definition data registration/edition portion 181 obtains the function BOX process definition data from input portion 109A. On the other hand, in editing, the user operates input portion 109A to input a change of the function BOX process definition data, so that input portion 109A accepts the changed function BOX process definition data, and function BOX process definition data 181 obtains the changed function BOX process definition data from input portion 109A. A change of function BOX process definition data includes a change of a parameter. When a parameter refers to destination data 125, a change of function BOX process definition data includes a change of a parameter that refers to destination data 125. In registration, function BOX process definition data registration/edition portion 181 stores the obtained function BOX process definition data into storage portion 102. Function BOX process definition data 123 is thus stored in storage portion 102. Function BOX process definition data registration/edition portion 181 may receive function BOX process definition data 123 from a computer connected through network I/F 107 or modem 108 for storage into storage portion 102. Alternatively, function BOX process definition data registration/edition portion 181 may read function BOX process definition data 123 stored in IC card 110A for storage into storage portion 102. In editing, function BOX process definition data registration/edition portion 181 updates function BOX process definition data 123 stored in storage portion 102 with the changed function BOX process definition data and also outputs the function BOX process No. for specifying the changed function BOX process definition data to function BOX process definition data change detection portion 183.

Function BOX process definition data change detection portion 183 detects a change of function BOX process definition data 123 stored in storage portion 102. At the time when the function BOX process definition data is updated by function BOX process definition data registration/edition portion 181, function BOX process definition data change detection portion 183 receives the function BOX process No. for specifying that function BOX process definition data from function BOX process definition data registration/edition portion 181. In addition, at the time when the function BOX process definition data is changed by function BOX process definition data change portion 182 as described later, function BOX process definition data change detection portion 183 receives the function BOX process No. for specifying that function BOX process definition data from function BOX process definition data change portion 182.

Upon reception of the function BOX process No. for specifying the changed function BOX process definition data 123 from function BOX process definition data registration/edition portion 181 or function BOX process definition data change portion 182, function BOX process definition data change detection portion 183 outputs that function process BOX process No. to inconsistency detection portion 173 and related data search portion 170.

Related data search portion 170 receives the function BOX process No. for specifying the changed function BOX process definition data 123 from function BOX process definition data change portion 182 and also receives the destination No. for specifying the changed destination data 125 from destination data change portion 192.

When the function BOX process No. for specifying the changed function BOX process definition data 123 is input from function BOX process definition data change portion 182, related data search portion 170 searches program key definition data 121 stored in storage portion 102, extracts program key definition data 121 that defines the changed function BOX process definition data 123 in the destination data, and outputs the extracted program key definition data 121 to inconsistency detection portion 173.

On the other hand, when the destination No. for specifying the changed destination data 125 is input from destination data change portion 192, related data search portion 170 searches program key definition data 121 stored in storage portion 102, extracts program key definition data 121 that refers to the changed destination data 125, and outputs the extracted program key definition data 121 to inconsistency detection portion 173. In addition, related data search portion 170 searches function BOX process definition data 123 stored in storage portion 102, extracts function BOX process definition data 123 that refers to the changed destination data 125, and outputs the extracted function BOX process definition data 123 to inconsistency detection portion 173. Specifically, upon reception of the destination No. for specifying the changed destination data 125, related data search portion 170 extracts program key definition data 121 that defines the input destination No. from program key definition data 121 stored in storage portion 102 and also extracts function BOX process definition data 123 that defines the input destination No. from function BOX process definition data 123 stored in storage portion 102.

In the automatic correction mode, upon reception of an instruction to automatically correct from change instruction accepting portion 175, function BOX process definition data change portion 182 changes the parameter corresponding to each process such that the parameter of function BOX process definition data 123 to be processed is consistent with a plurality of processes. Specifically, function BOX process definition data change portion 182 changes the parameter corresponding to the process other than the output process that defines destination data as a parameter such that it is consistent with the changed output process. A parameter corresponding to the process other than the output process may be stored beforehand in association with each of a plurality of output processes. Specifically, if a data transmission process and output destination information are defined as an output process by function BOX process definition data 123, when the defined data transmission process is changed, function BOX process definition data change portion 182 changes the parameter corresponding to the process other than the output process such that it is consistent with the changed data transmission process. Function BOX process definition data change portion 182 stores beforehand the parameter corresponding to the process other than the output process in association with each of a plurality of data transmission processes in order to decide on a parameter after change. Here, function BOX process definition data change portion 182 stores a parameter by default corresponding to the image reading process in association with each of the facsimile transmission process and the processes other than the facsimile transmission process. In addition, if the data processing and a file format are defined as an output process by function BOX process definition data 123, when the defined output process is changed, function BOX process definition data change portion 182 changes the parameter corresponding to the process other than the output process such that it is consistent with a file format that allows the changed data processing to be processed. Function BOX process definition data change portion 182 stores a parameter by default for each process other than the output process in association with a data file format in order to decide on a parameter after change. Here, function BOX process definition data change portion 182 stores a parameter by default corresponding to the image reading process in association a data file format.

If the parameter corresponding to the output process defined by function BOX process definition data 123 refers to destination data 125, function BOX process definition data change portion 182 specifies destination data 125 based on that parameter. Function BOX process definition data change portion 182 changes the parameter corresponding to the process other than the output process such that it is consistent with an output method defined by the specified destination data. If the output method defined by the specified destination data 125 is “human designated transmission,” function BOX process definition data change portion 182 specifies a home terminal based on user identification information and obtains user information from the specified home terminal. Then, function BOX process definition data change portion 182 specifies the output method based on the obtained user information and changes the parameter corresponding to the process other than the output process such that it is consistent with the specified output method.

In the simple correction mode, function BOX process definition data change portion 182 specifies a parameter that requires correction from function BOX process definition data 123. Specifically, similarly to the automatic correction mode, function BOX process definition data change portion 182 changes a parameter corresponding to each process such that the parameter of function BOX process definition data 123 to be processed is consistent with a plurality of processes. A parameter that is different between before change and after change is determined as a parameter that requires correction. Function BOX process definition data change portion 182 outputs the information specifying a parameter requiring correction from function BOX process definition data 123 to change instruction accepting portion 175. In the simple correction mode or the detailed correction mode, upon reception of the changed function BOX process definition data 123 from change instruction accepting portion 175, function BOX process definition data change portion 182 stores the changed function BOX process definition data 123 into storage portion 102.

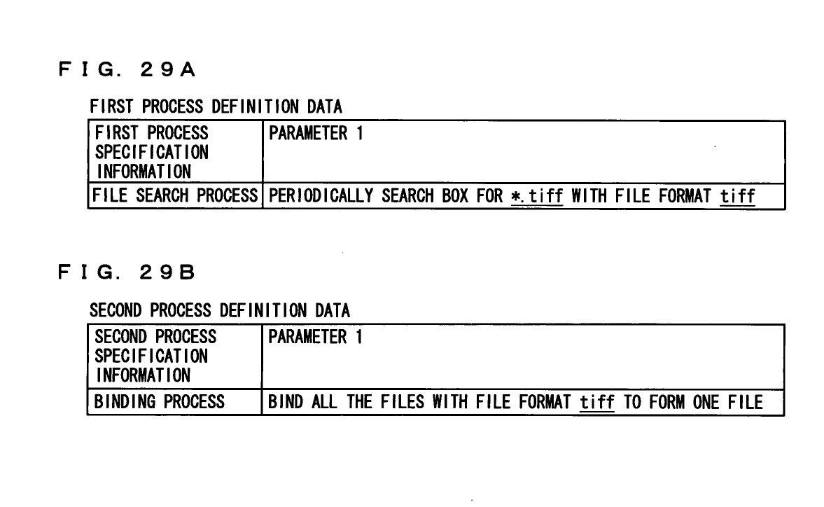

Now, a specific example where the function BOX process definition data is changed will be described. FIGS. 29A and 29B are diagrams showing exemplary function BOX process definition data after a change. FIG. 29A shows first process definition data of function BOX process definition data after a change. The changed portion of the first process definition data shown in FIG. 28B is underlined. FIG. 29B is a diagram showing second process definition data of function BOX process definition data after a change. The changed portion of the second process definition data shown in FIG. 28C is underlined. Referring to FIGS. 29A and 29B, the file format has been changed from JPEG to TIFF.

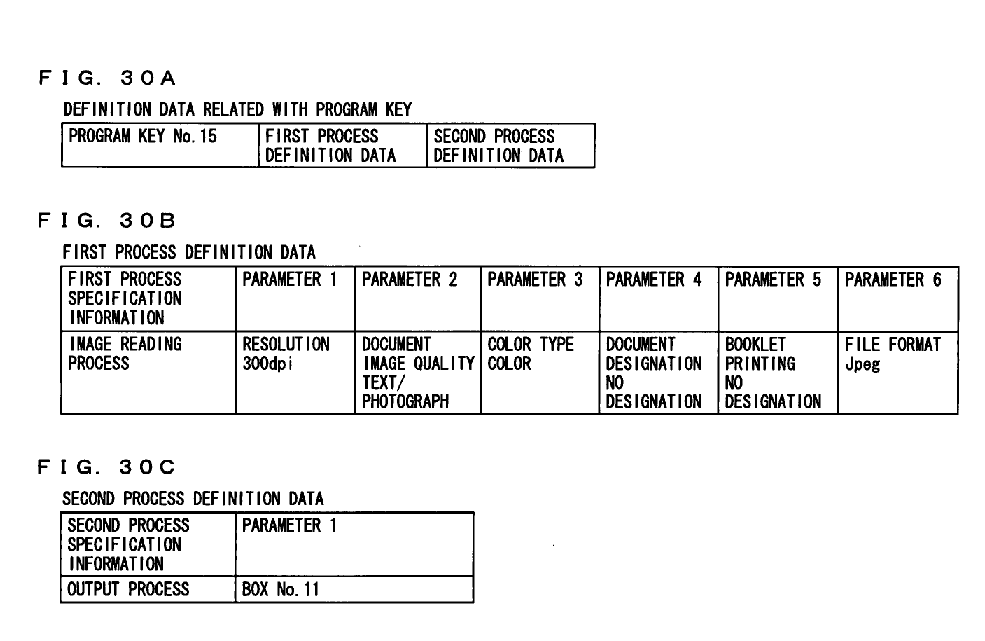

FIG. 30A is a diagram showing an exemplary format of program key definition data. FIG. 30B is a diagram showing exemplary first process definition data. FIG. 30C is another diagram showing exemplary second process definition data. The process specification information defines “output process” and the parameter defines “BOX No. 11.” The program key definition data defines the output process in the second process definition data in which “BOX No.11” is defined by the parameter. In FIGS. 28A-28C, the function BOX process definition data corresponding to BOX No. 11 is shown. The function BOX process definition data corresponding to this BOX No.11 has the first process definition data and the second process definition data changed as shown in FIGS. 29A and 29B, by way of illustration. In the file search process and the binding process defined by the function BOX process definition data before the change, the file format of a file to be processed is JPEG. Correspondingly, the image reading process and the output process are defined by the program key definition data shown in FIGS. 30A-30C, where JPEG is defined by parameter 6 as the file format of a file output by the image reading process. Therefore, the file format of a file output by execution of the process defined by the program key definition data agrees with the file format of a file to be processed by the process defined by the function BOX process definition data. Thus, the parameter in each definition data is consistent.

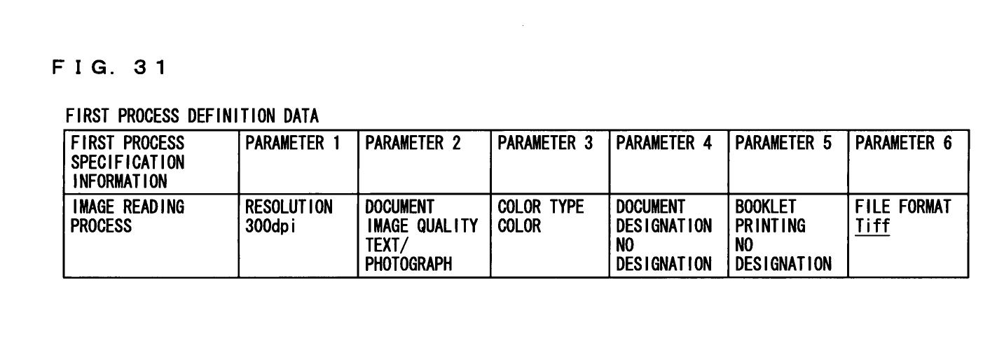

On the other hand, as shown in FIGS. 29A and 29B, when the function BOX process definition data is changed, the parameter in each definition data becomes inconsistent, since the file format of a file output by execution of the process defined by the program key definition data is JPEG (Joint Photographic Experts Group) while the file format of a file to be processed by the process defined by the function BOX process definition data is TIFF (Tagged Image File Format). Therefore, in MFP 100, when the function BOX process definition data is changed, the program key definition data is changed so that the process defined by the function BOX process definition data can be executed. Here, parameter 6 in the first process definition data of the program key definition data is changed to achieve consistency. FIG. 31 shows exemplary first process definition data of the program key definition data after the change. When the function BOX process definition data is changed, the program key definition data that defines the function BOX process definition data in the output process is changed without changing the function BOX process definition data. Thus, a change of function BOX process definition data can be respected.

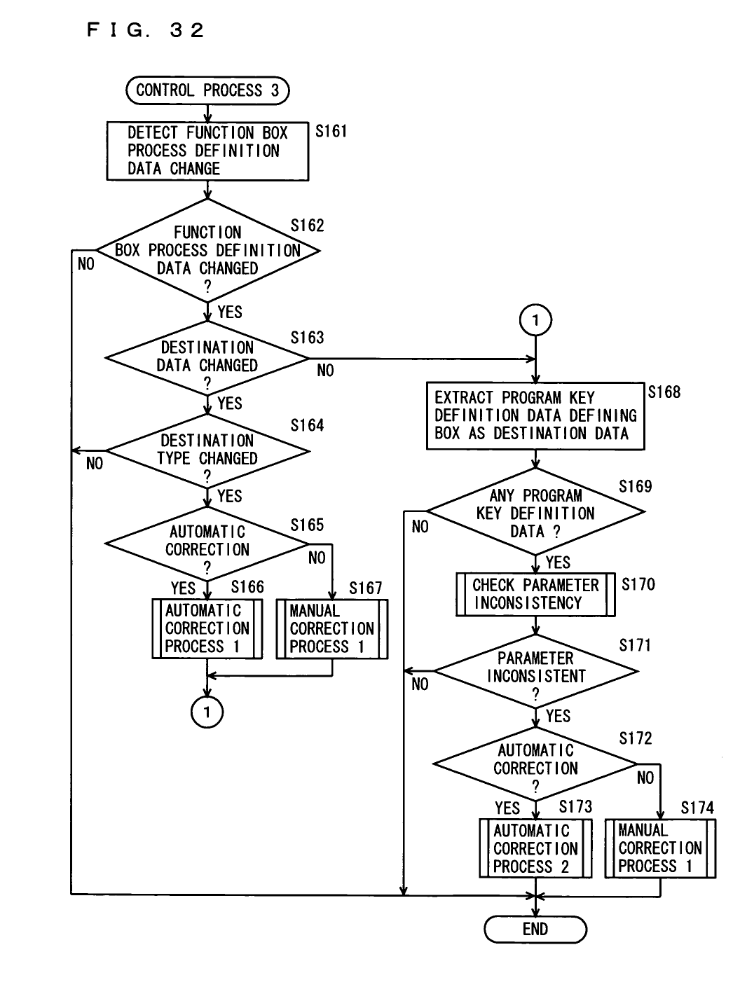

FIG. 32 is a third flowchart illustrating an exemplary flow of a control process executed in MFP in accordance with the second embodiment. This control process is executed in CPU 101 by CPU 101 of MFP 100 loading and executing the control program stored in ROM of storage portion 102. Desirably, this control process has the execution timing scheduled to start, for example, at a prescribed time once a day. However, it may start at irregular intervals upon the user's instruction. Referring to FIG. 32, CPU 101 detects a change of function BOX process definition data 123 stored in storage portion 102 (step S161). It is noted that if a plurality of function box process definition data are detected at step S161, the processes following step S162 are executed for each of a plurality of function BOX process definition data. If a change of function BOX process definition data 123 is detected (YES at step S162), the process proceeds to step S163, and if a change is not detected (NO at step S162), the process ends. Then, it is determined whether or not the output process defined by the changed function BOX process definition data 123 is changed (step S163). A change of the output process is a change of destination data 125 that is the parameter corresponding to the output process. In other words, a change of program key definition data includes a change of the parameter corresponding to the output process. If CPU 101 detects a change of function BOX process definition data 123, the changed function BOX process definition data 123 is specified, and the process proceeds to step S164. If a change of function BOX process definition data 123 is not detected, the process proceeds to step S168.

At step S164, CPU 101 determines whether or not the destination type of the destination data which is determined as being changed at step S163 is changed. If the destination type is changed from Fax type to Scan type, or if the destination type is changed from Scan type to Fax type, CPU 101 proceeds to step S165. If the destination type is not changed, the process ends.

At step S165, CPU 101 determines whether or not MFP 100 is set in the automatic correction mode. If set in the automatic correction mode, the process proceeds to step S166, and if not set in the automatic correction mode, the process proceeds to step S167. CPU 101 executes the automatic correction process at step S166 and proceeds to step S168. At step S166, the automatic correction process similar to that shown in FIG. 11 is executed. However, it is different in that the data to be corrected is the program key definition data in FIG. 11 while it is the function BOX process definition data in step S166. At step S167, the manual correction process is performed, and the process proceeds to step S168. At step S167, the manual correction process similar to that shown in FIG. 22 is executed. However, it is different in that the data to be corrected is the program key definition data in FIG. 11 while it is the function BOX process definition data in step S167.

At step S168, the program key definition data that defines a function BOX (here, BOX No. 11) related with the changed function BOX process definition data as destination data is extracted from program key definition data 121 stored in storage portion 102 (step S168). The changed function BOX process definition data is the function BOX process definition data that is detected as being changed at step S162 or the function BOX process definition data that is corrected at step S166 or step S167.

At step S169, it is determined whether or not program key definition data 121 that defines the function BOX related with the changed function BOX process definition data as destination data is extracted. If extracted, the process proceeds to step S170, and if not extracted, the process ends. This is because a change of function BOX process definition data 123 may bring about inconsistency with the program key definition data that defines that function BOX process definition data 123 in the destination data.

At step S170, a parameter inconsistency check process is executed. The parameter inconsistency check process, which will be described later, is a process of determining whether or not inconsistency of a parameter with a changed function box process definition data exists in program key definition data 121 extracted at step S168.

At step S171, based on the result of the parameter inconsistency check process, it is determined whether or not inconsistency occurs. If inconsistency occurs, the process proceeds to step S172, and if no inconsistency occurs, the process ends. In the case of consistency, there is no need for changing a parameter.

At step S172, CPU 101 determines whether or not MFP 100 is set in the automatic correction mode. If set in the automatic correction mode, the process proceeds to step S173, and if not set in the automatic correction mode, the process proceeds to step S174. CPU 101 executes a different automatic correction process as described later at step S173 and executes the manual correction process shown in FIG. 22 at step S167.

It is noted that if a plurality of program key definition data are extracted at step S168, the processes at step S170-step S174 are executed for each of a plurality of program key definition data.

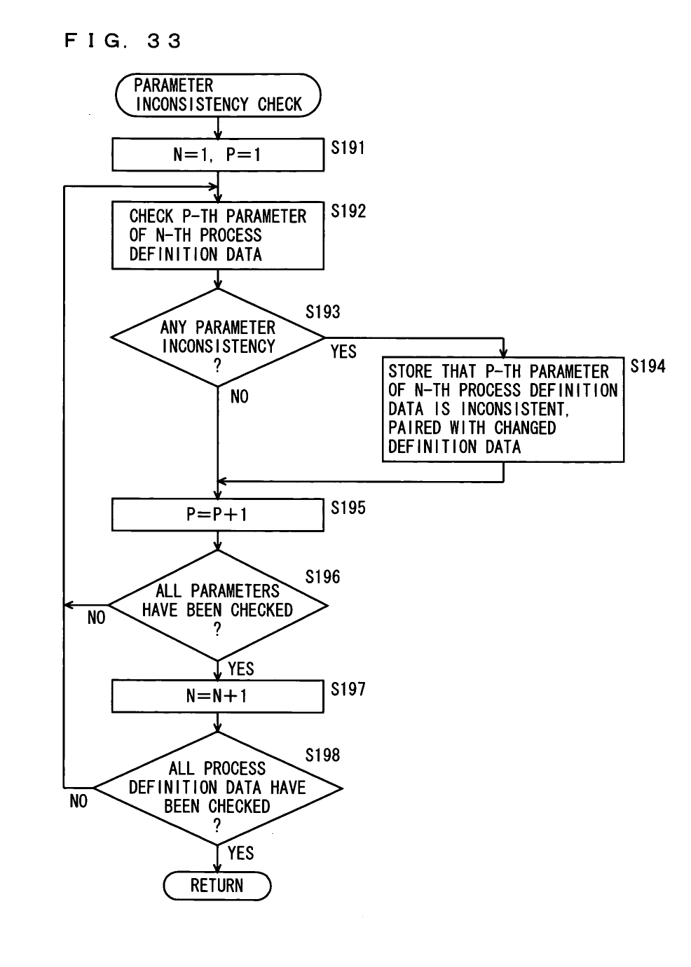

FIG. 33 is a diagram illustrating an exemplary flow of a parameter inconsistency check process. The parameter inconsistency check process is a process executed in step S170 in FIG. 32. Referring to FIG. 33, CPU 101 initializes variable N and variable P at “1” (step S191). At the next step S192, the P-th parameter of the N-th process definition data included in the program key definition data is checked. In this checking, it is determined whether or not the process defined by the changed function BOX process definition data is executable. At step S193, based on the checking result at step S192, it is determined whether or not the parameter is inconsistent. If inconsistent, the process proceeds to step S194, and if consistent, step S194 is skipped and the process proceeds to step S195. At step S194, it is stored that the P-th parameter of the N-th process definition data is inconsistent, paired with the changed function BOX process definition data.

At step S195, 1 is added to variable P, and the process proceeds to step S196. At step S196, it is determined whether or not all parameters have been checked for the N-th process definition data. If all have been checked, the process proceeds to step S197, and if not yet, the process returns to step S192. At step S197, 1 is added to variable N, and the process proceeds to step S198. At step S198, it is determined whether or not all of the process definition data have been checked. If all have been checked, the process ends, and if not yet, the process returns to step S192.

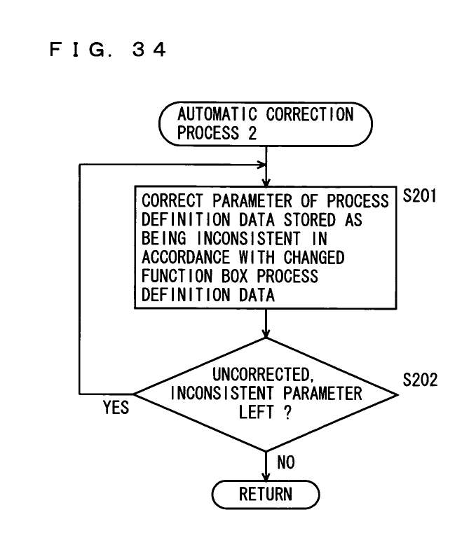

FIG. 34 is another flowchart illustrating a flow of an automatic correction process. The automatic correction process shown in FIG. 34 is a process executed in step S173 in FIG. 32. Referring to FIG. 34, at step S201, the parameter of the process definition data stored as being inconsistent is corrected in accordance with the changed function BOX process definition data. At the next step S202, it is determined whether or not any uncorrected parameter exists among the parameters of the process definition data stored as being inconsistent. If such a parameter exists, the process returns to step S201, and if not, the process returns to the control process in FIG. 32.

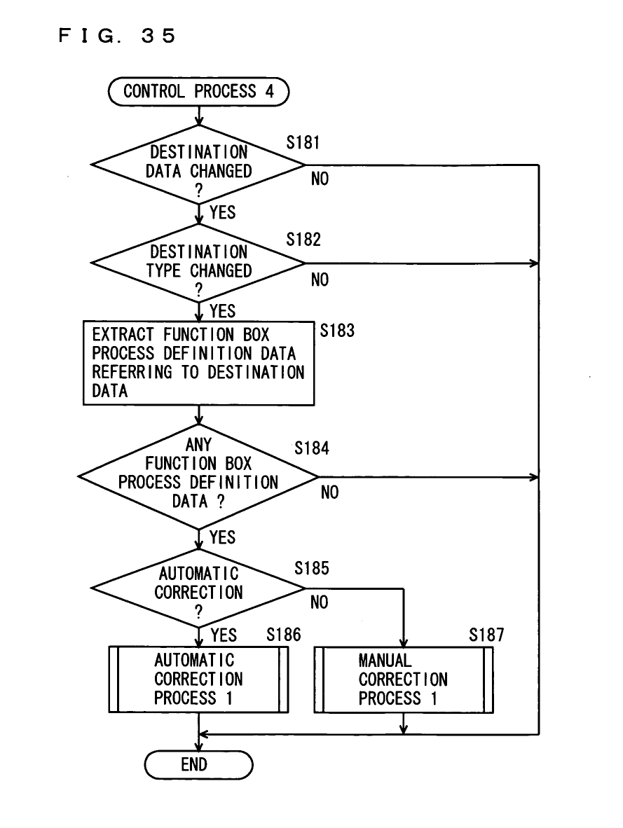

FIG. 35 is a fourth flowchart illustrating an exemplary flow of a control process executed in MFP in accordance with the second embodiment. This control process is executed in CPU 101 by CPU 101 of MPF 100 loading and executing the control program stored in ROM of storage portion 102. Desirably, this control process has the execution timing scheduled to start, for example, at a prescribed time once a day. However, it may start at irregular intervals upon the user's instruction.

Referring to FIG. 35, CPU 101 detects a change of destination data 125 stored in storage portion 102 (step S181). If a change of the destination data is detected, the process proceeds to step S182, and if not, the process ends. At step S182, it is determined whether or not the destination type of destination data 125 detected at step S181 is changed. The destination type refers to a type of an output method. If the destination type is changed from Fax type to Scan type, or if the destination type is changed from Scan type to Fax type, CPU 101 proceeds to step S183. If the destination type is not changed, the process ends.

At step S183, all the function BOX process definition data 123 that refer to destination data 125 detected at step S181 are extracted from function BOX process definition data 123 stored in storage portion 102. At the next step S184, it is determined whether or not function BOX process definition data 123 is extracted at step S183. If any of function BOX process definition data 123 is extracted, the process proceeds to step S185. If none is extracted, the process ends. The processes at step S185-step S187 are the same as step S165-step S167 shown in FIG. 32, respectively, and therefore the description will not be repeated here. It is noted that if a plurality of function BOX process definition data 123 are extracted at step S183, the processes at step S185-step S187 are executed for each of the extracted plurality of function BOX process definition data 123.

As described above, MFP 100 in accordance with the second embodiment includes: storage portion 102 storing program key definition data 121 defining the image reading process and the output process; process execution portion 150 reading program key definition data 121 from storage portion 102 to execute the image reading process and the output process defined by program key definition data 121; program key change detection portion 162 detecting that the output process defined by the stored program key definition data 121 has been changed; and program key change portion 163 changing the image reading process defined by the changed program key definition data 121.

In addition, storage portion 102 stores function BOX process definition data 123 that defines at least one process. The output process of the program key definition data is associated with a parameter referring to function BOX process definition data 123. Process execution portion 150 executes at least one process defined by function BOX process definition data 123 that is referred to by the parameter corresponding to the output process. When a parameter referring to the function BOX in the program key definition data is changed by program key registration/edition portion 161, that part of program key definition data 121 which defines the output process is changed, so that program key change portion 163 changes the image reading process. Therefore, it is possible to execute the process defined by function BOX process definition data 123 related with the function BOX after a parameter referring to the function BOX in the program key definition data is changed.

Furthermore, MFP 100 includes: storage portion 102 storing program key definition data 121 defining the image reading process and the output process and function BOX process definition data related with program key definition data 121 and defining the output process; process execution portion 150 reading program key definition data 121 from storage portion 102 to execute the image reading process and the output process defined by program key definition data 121; function BOX process definition data change detection portion 183 detecting a change of the function BOX process definition data; and program key change portion 163 changing program key definition data 121 related with function BOX process definition data 123 in response to a change of function BOX process definition data 123. Therefore, when function BOX process definition data 123 is changed, program key definition data 121 related with function BOX process definition data 123 is changed, so that it is possible to easily change a part of the settings for executing the image reading process and the output process defined by program key definition data 121.

Furthermore, MFP 100 includes: storage portion 102 storing function BOX process definition data 123 defining at least one process at least including the output process and destination data 125 related with function BOX process definition data 123 and defining the output process; process execution portion 150 reading function BOX process definition data 123 from storage portion 102 to execute the output process defined by function BOX process definition data 123; destination data change portion 192 detecting a change of destination data 125; and function BOX process definition data change portion 182 changing function BOX process definition data 123 related with destination data 125 in response to a change of destination data 125. Therefore, when destination data 125 is changed, function BOX process definition data 123 related with destination data 125 is changed, so that it is possible to easily change a part of the settings for executing at least one process defined by function BOX process definition data 123.

Storage portion 102 stores a plurality of program key definition data 121. MFP 100 further includes related data search portion 170 extracting program key definition data 121 related with the changed destination data 125 or function BOX process definition data 123 from a plurality of program key definition data 121, when destination data 125 or function BOX process definition data 123 is changed. Therefore, if a plurality of program key definition data 121 are related to one common destination data or function BOX process definition data 123, the image reading process and the output process defined by a plurality of program key definition data can be executed properly even when such destination data 125 or function BOX process definition data 123 is changed.

It is noted that in the present embodiment, MFP 100 has been described as an example of an information processing apparatus. However, it is needless to say that the present invention can be understood as a method of causing MFP 100 to execute the control process shown in FIGS. 10-24, FIG. 26, FIG. 32 and FIG. 33 and a control program executed in CPU 101 to cause MFP 100 to execute the control process. In addition, although, in the present embodiment, the user interface of MFP 100 has been described as operation panel 109, MFP 100 can be operated remotely, for example, from computer 200, in which case, computer 200 serves as a user interface.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information processing apparatus comprising:
a storage portion to store definition data defining a plurality of series of processes;
a process execution portion to read said definition data from said storage portion to execute said plurality of series of processes defined by said definition data;
a change detection portion to detect that a part of said plurality of series of processes defined by said stored definition data is changed; and
a definition data change portion to change a process other than said changed process of said plurality of series of processes defined by the definition data detected by said change detection portion.

2. The information processing apparatus according to claim 1, wherein
said definition data further defines a parameter corresponding to each of said plurality of processes,
said process execution portion reads said definition data from said storage portion to execute each of said plurality of series of processes defined by said definition data according to a corresponding parameter, and
said definition data change portion includes a parameter change portion to change a parameter corresponding to a process other than said changed process of said plurality of series of processes.

3. The information processing apparatus according to claim 1, further comprising a destination data storing portion to store a plurality of destination data, each defining an output method and output destination information for specifying an output destination, wherein
that portion of said definition data which defines said part of said plurality of series of processes defines a reference parameter referring to one of said plurality of destination data and an output process of receiving data to output said data to said output destination in said output method defined by said destination data that is referred to by said reference parameter, and
said change detection portion detects a change of said reference parameter.

4. The information processing apparatus according to claim 1, further comprising a change permission request portion to request an input of a change permission, wherein said definition data change portion changes a process other than said changed process of said plurality of series of processes on condition that said change permission is input.

5. The information processing apparatus according to claim 1, further comprising:
a change request portion to request a change of a process requiring a change of said plurality of series of processes defined by said changed definition data; and
a change accepting portion to accept an input of a change by a user in response to said change request, wherein
said definition data change portion makes a change according to said input change.

6. An information processing apparatus comprising:
a first definition data storing portion to store first definition data defining a plurality of series of processes;
a process execution portion to read said first definition data from said first definition data storing portion to execute said plurality of series of processes defined by said first definition data;
a second definition data storing portion to store second definition data related with said first definition data to define a partial process that is a part of said plurality of series of processes;
a change detection portion to detect a change of said second definition data stored in said second definition data storing portion; and
a change portion to change said first definition data related with said second definition data, in response to a change of said second definition data.

7. The information processing apparatus according to claim 6, wherein
said first definition data storing portion stores a plurality of said first definition data, and
said information processing apparatus further comprises an extraction portion, in response to detection of a change of said second definition data by said change detection portion, to extract related first definition data that is related with said changed second definition data from a plurality of said first definition data stored in said first definition data storing portion.

8. The information processing apparatus according to claim 6, wherein
said first definition data further defines a parameter corresponding to each of said plurality of processes,
said process execution portion reads said first definition data from said first definition data storing portion to execute each of said plurality of series of processes defined by said first definition data according to a corresponding parameter, and
said change portion includes a parameter change portion to change a parameter corresponding to a process other than said partial process of said plurality of series of processes.

9. The information processing apparatus according to claim 6, wherein
said second definition data defines an output method and output destination information for specifying an output destination, and
said change detection portion detects a change of said output method defined by said second definition data.

10. The information processing apparatus according to claim 6, wherein
said second definition data defines data processing of processing data in a predetermined file format, and
said change detection portion detects a change of the file format defined by said second definition data.

11. A control program embodied in a computer readable medium comprising:
a step of storing definition data defining a plurality of series of processes;
a step of reading said stored definition data to execute said plurality of series of processes defined by said definition data;
a change detection step of detecting that a part of said plurality of series of processes defined by said stored definition data is changed; and
a step of changing said definition data by changing a process other than the changed process of said plurality of series of processes defined by said changed definition data.

12. The control program embodied in a computer readable medium according to claim 11, wherein
said definition data further defines a parameter corresponding to each of said plurality of processes,
said step of executing a process includes a step of reading said stored definition data to execute each of said plurality of series of processes defined by said definition data according to a corresponding parameter, and
said step of changing the definition data includes a step of changing a parameter corresponding to a process other than said changed process of said plurality of series of processes.

13. The control program embodied in a computer readable medium according to claim 11, further comprising a step of storing a plurality of destination data defining an output method and output destination information for specifying an output destination, wherein
that part of said definition data which defines a part of said plurality of series of processes defines a reference parameter referring to one of said plurality of destination data and an output process of receiving data to output said data to said output destination in said output method defined by said destination data that is referred to by said reference parameter, and
said change detection step includes a step of detecting a change of said reference parameter.

14. The control program embodied in a computer readable medium according to claim 11, further comprising a step of requesting an input of a change permission, wherein
said step of changing the definition data includes a step of changing a process other than said changed process of said plurality of series of processes on condition that said change permission is input.

15. The control program embodied in a computer readable medium according to claim 11, further comprising:
a step of requesting a change of a process requiring a change of said plurality of series of processes defined by said changed definition data; and
a step of accepting an input of a change by a user in response to said change request, wherein
said step of changing the definition data includes a step of making a change according to said input change.

16. A control program embodied in a computer readable medium comprising the steps of:
storing first definition data defining a plurality of series of processes;
reading said stored first definition data to execute said plurality of series of processes defined by said first definition data;
storing second definition data related with said first definition data to define a partial process that is a part of said plurality of series of processes;
detecting a change of said stored second definition data; and
changing said first definition data related with said second definition data, in response to a change of said second definition data.

17. The control program embodied in a computer readable medium according to claim 16, wherein
in said step of storing said first definition data, a plurality of said first definition data are stored, and
said control program further comprises a step of, in response to detection of a change of said second definition data, extracting related first definition data related with said changed second definition data from a plurality of said first definition data.

18. The control program embodied in a computer readable medium according to claim 16, wherein
said first definition data further defines a parameter corresponding to each of said plurality of processes,
said step of executing a process includes a step of reading said first definition data to execute each of said plurality of series of processed defined by said first definition data according to a corresponding parameter, and
said step of changing the first definition data includes a step of changing a parameter corresponding to a process other than said partial process of said plurality of series of processes.

19. The control program embodied in a computer readable medium according to claim 16, wherein
said second definition data defines an output method and output destination information for specifying an output destination, and
said step of changing the first definition data includes a step of detecting a change of said output method defined by said second definition data.

20. The control program embodied in a computer readable medium according to claim 16, wherein
said second definition data defines data processing of processing data in a predetermined file format, and
said step of changing the first definition data includes a step of detecting a change of the file format defined by said second definition data.
